(19) United States
(12) Patent Application Publication
(10) Pub. No.: US 2026/0040230 A1
(43) Pub. Date: Feb. 5, 2026

(54) METHOD AND DEVICE FOR POWER CONTROL IN COMMUNICATION SYSTEM

(71) Applicant: ELECTRONICS AND TELECOMMUNICATIONS RESEARCH INSTITUTE, Daejeon (KR)

(72) Inventor: Hoon Dong NOH, Daejeon (KR)

(21) Appl. No.: 18/996,667

(22) PCT Filed: Aug. 21, 2023
(86) PCT No.: PCT/KR2023/012329

§ 371 Date: Jan. 17, 2025

(30) Foreign Application Priority Data
Aug. 29, 2022 (KR) 10-2022-0108472

(51) Int. Cl. H04W 52/14

(52) U.S. Cl. CPC H04W 52/146

(57) ABSTRACT

An operation method of a first device may comprise the steps of: receiving device control information for controlling the first device from a second device; identifying one or more types of power control information, which are included in the device control information and related to uplink power control of the first device; identifying an association relationship between the one or more types of power control information and one or more resources for uplink transmission of the first device; and on the basis of the one or more types of power control information associated with the one or more resources, determining one or more uplink transmission power values corresponding to the one or more resources.

### TECHNICAL FIELD

The present disclosure relates to a power control technique for a communication system, and more particularly, to a power control technique for a communication system using a wireless repeater for coverage extension.

### BACKGROUND ART

With the development of information and communication technology, various wireless communication technologies are being developed. Representative wireless communication technologies include long-term evolution (LTE) and new radio (NR) defined as the 3rd generation partnership project (3GPP) standards. The LTE may be one of the 4th generation (4G) wireless communication technologies, and the NR may be one of the 5th generation (5G) wireless communication technologies.

In order to process the rapid increase in wireless data, 5G NR communication or later wireless communication technologies can support communication in relatively high frequency bands. For example, radio frequency bands used for wireless communication may be broadly classified into a frequency range 1 (FR1) band and a frequency range 2 (FR2) band. Here, the FR1 band may refer to a relatively low frequency band of 6 GHz or below. The FR2 band may refer to a relatively high frequency band of 6 GHz or above. For example, the FR2 band may include a 28-29 GHz band, millimeter wave band, or terahertz wave band.

A wireless repeater may refer to a communication node that relays wireless signals transmitted and received between different communication nodes. The repeater may also be referred to as ‘relay’. An exemplary embodiment of the wireless repeater may simply amplify a received signal and retransmit it. Meanwhile, another exemplary embodiment of the wireless repeater may be a network-controlled (NWC) repeater controlled by a base station. In the NWC repeater, devices for receiving a control signal from the base station and transmitting a response therefor, etc. to the base station may be added in addition to devices for amplifying and retransmitting a received signal. In addition to amplifying and retransmitting an uplink signal from a terminal, the NWC repeater may need to perform a function of transmitting its own uplink signal. For the NWC repeater, a transmission power control technique for two different types of uplink signals may be required.

Matters described as the prior arts are prepared to promote understanding of the background of the present disclosure, and may include matters that are not already known to those of ordinary skill in the technology domain to which exemplary embodiments of the present disclosure belong.

### DISCLOSURE

### Technical Problem

The present disclosure is directed to providing a method and an apparatus for efficiently controlling transmission powers of various types of uplink signals in a repeater used for increasing a radio network performance gain.

### Technical Solution

A first exemplary embodiment of an operation method of a first device may comprise: receiving device control information for controlling the first device from a second device; identifying one or more types of power control information related to uplink power control of the first device, which are included in the device control information; identifying an association relationship between the one or more types of power control information and one or more resources for uplink transmission of the first device; and determining one or more uplink transmission power values corresponding to the one or more resources, based on the one or more types of power control information associated with the one or more resources.

The operation method may further comprise, before the determining of the one or more uplink transmission power values, identifying information on a multiplexing mode applied to each of the one or more resources, wherein the one or more types of power control information indicate one or more power reference values used to determine the one or more uplink transmission power values, and size(s) of the one or more power reference values indicated by the one or more types of power control information are determined differently depending on the multiplexing mode applied to each of the one or more resources associated with the one or more types of power control information.

The one or more types of power control information may include control information #1 and control information #2, the one or more resources may include a resource #1 and a resource #2, the control information #1 associated with the resource #1 may indicate a power reference value #1 used to determine an uplink transmission power value corresponding to the resource #1, the control information #2 associated with the resource #2 may indicate a power reference value #2 used to determine an uplink transmission power value corresponding to the resource #2, a multiplexing based on a time division scheme may be applied to the resource #1, a multiplexing based on at least one a frequency division scheme or a space division scheme may be applied to the resource #2, and the power reference value #1 may be greater than the power reference value #2.

The operation method may further comprise: when the first device relays communication between a third device and the second device, and one or more links are formed at least one of between the first and second devices and between the first and third devices, identifying link ON/OFF control information that is received from the second device and indicates a period in which each of the one or more links is turned on/off, before determining the one or more uplink transmission power values, wherein the one or more types of power control information indicate one or more power reference values used to determine the one or more uplink transmission power values, and size(s) of the one or more power reference values indicated by the one or more types of power control information are determined differently depending on whether a link is turned on/off in the one or more resources associated with the one or more types of power control information.

The one or more types of power control information may include control information #3 and control information #4, the one or more resources may include a resource #3 and a resource #4, the control information #3 associated with the resource #3 may indicate a power reference value #3 used to determine an uplink transmission power value corresponding to the resource #3, the control information #4 associated with the resource #4 may indicate a power reference value #4 used to determine an uplink transmission power value corresponding to the resource #4, a first link among the one or more links may be turned off in a time period where the resource #3 is located and turned on in a time period where the resource #4 is located, based on the link ON/OFF control information, and the power reference value #3 may be greater than the power reference value #4.

The operation method may further comprise: when the first device relays communication between a third device and the second device, and one or more links are formed at least one of between the first and second devices and between the first and third devices, identifying communication direction control information that is received from the second device and indicates a communication direction of each of the one or more links, before determining the one or more uplink transmission power values, wherein the one or more types of power control information indicate one or more power reference values used to determine the one or more uplink transmission power values, and size(s) of the one or more power reference values indicated by the one or more types of power control information are determined differently depending on communication direction(s) in the one or more resources associated with the one or more types of power control information.

The one or more types of power control information may include control information #5 and control information #6, the one or more resources may include a resource #5 and a resource #6, the control information #5 associated with the resource #5 may indicate a power reference value #5 used to determine an uplink transmission power value corresponding to the resource #5, the control information #6 associated with the resource #6 may indicate a power reference value #6 used to determine an uplink transmission power value corresponding to the resource #6, a second link among the one or more links may be configured as a downlink in a time period where the resource #5 is located, and may be configured as an uplink in a time period where the resource #6 is located, based on the communication direction control information, and the power reference value #5 may be greater than the power reference value #6.

The one or more types of power control information may indicate one or more power reference values used to determine the one or more uplink transmission power values, and size(s) of the one or more power reference values indicated by the one or more types of power control information may be determined differently depending on types of signals transmitted and received through the one or more resources associated with the one or more types of power control information.

The determining of the one or more uplink transmission power values may comprise: determining one or more transmission power candidate values respectively corresponding to the one or more resources; in response to that a sum of the one or more transmission power candidate values exceeds a preset available transmission power value, comparing respective priorities of the one or more resources; and readjusting at least some of the one or more transmission power candidate values, based on the respective priorities of the one or more resources and the available transmission power value.

The comparing of the respective priorities of the one or more resources may comprise: determining that a priority of a resource for a backhaul link among the one or more resources is higher than a priority of a resource for a control link.

The comparing of the respective priorities of the one or more resources may comprise: determining that a priority of a resource for a control link among the one or more resources is higher than a priority of a resource for a backhaul link.

The comparing of the respective priorities of the one or more resources may comprise: determining that a priority of a resource for a cell-specific signal among the one or more resources is higher than a priority of a resource for a terminal-specific signal.

The operation method may further comprise, before determining the one or more uplink transmission power values, identifying a first signaling received from the second device, wherein the first signaling indicates the first device to apply a multiplexing based on a time division scheme to a resource for a cell-specific signal.

The first device may be a repeater and the second device may be a base station that communicates with a terminal through the repeater, a control link for controlling the first device and a backhaul link for communication between the second device and the terminal may be formed between the first and second devices, and each of the one or more resources may correspond to at least one of the backhaul link or the control link.

The first device may relay communication between a third device and the second device, a control link for controlling the first device and a backhaul link for communication between the second and third devices may be formed between the first device and the second device, and an access link for communication between the second and third devices may be formed between the first and third devices.

An exemplary embodiment of a first device may comprise a processor, and the processor may cause the first device to perform: receiving device control information for controlling the first device from a second device; identifying one or more types of power control information related to uplink power control of the first device, which are included in the device control information; identifying an association relationship between the one or more types of power control information and one or more resources for uplink transmission of the first device; and determining one or more uplink transmission power values corresponding to the one or more resources, based on the one or more types of power control information associated with the one or more resources.

The processor may further cause the first device to perform: before the determining of the one or more uplink transmission power values, identifying information on a multiplexing mode applied to each of the one or more resources, wherein the one or more types of power control information indicate one or more power reference values used to determine the one or more uplink transmission power values, and size(s) of the one or more power reference values indicated by the one or more types of power control information are determined differently depending on the multiplexing mode applied to each of the one or more resources associated with the one or more types of power control information.

When the first device relays communication between a third device and the second device, and one or more links are formed at least one of between the first and second devices and between the first and third devices, the processor may further cause the first device to perform: identifying link ON/OFF control information that is received from the second device and indicates a period in which each of the one or more links is turned on/off, before determining the one or more uplink transmission power values, wherein the one or more types of power control information indicate one or more power reference values used to determine the one or more uplink transmission power values, and size(s) of the one or more power reference values indicated by the one or more types of power control information are determined differently depending on whether a link is turned on/off in the one or more resources associated with the one or more types of power control information.

When the first device relays communication between a third device and the second device, and one or more links are formed at least one of between the first and second devices and between the first and third devices, the processor may further cause the first device to perform: identifying communication direction control information that is received from the second device and indicates a communication direction of each of the one or more links, before determining the one or more uplink transmission power values, wherein the one or more types of power control information indicate one or more power reference values used to determine the one or more uplink transmission power values, and size(s) of the one or more power reference values indicated by the one or more types of power control information are determined differently depending on communication direction(s) in the one or more resources associated with the one or more types of power control information.

The one or more types of power control information may indicate one or more power reference values used to determine the one or more uplink transmission power values, and size(s) of the one or more power reference values indicated by the one or more types of power control information may be determined differently depending on types of signals transmitted and received in the one or more resources associated with the one or more types of power control information.

### Advantageous Effects

According to exemplary embodiments of a power control method and apparatus in a communication system, a repeater and a base station can communicate with each other through a control link used for controlling the repeater itself and a backhaul link used for relaying communication between a terminal and the base station. In order to efficiently determine uplink transmission powers of the repeater for the control link and backhaul link, a power control scheme and a power determination scheme can be used based on multiplexing mode information, link ON/OFF period information, uplink/downlink period information, and/or predetermined priority criteria. Accordingly, the repeater can efficiently transmit its own uplink signals and amplify and retransmit signals received from the terminal.

### DESCRIPTION OF DRAWINGS

FIG. 1 is a conceptual diagram illustrating an exemplary embodiment of a radio interface protocol structure in a communication system.

FIG. 2 is a conceptual diagram illustrating an exemplary embodiment of time resources in which radio signals are transmitted in a communication system.

FIG. 3 is a conceptual diagram illustrating a time difference between a reception timing of an i-th downlink frame and a transmission timing of an i-th uplink frame in an exemplary embodiment of a communication system.

FIG. 4 is a conceptual diagram illustrating an exemplary embodiment of a time/frequency resource grid of a communication system.

FIG. 5 is a conceptual diagram illustrating an exemplary embodiment of a synchronization signal and physical broadcast channel (SS/PBCH) block or synchronization signal block (SSB) of a communication system.

FIG. 6 is a sequence chart illustrating an exemplary embodiment of a random access procedure in a communication system.

FIG. 7 is a conceptual diagram illustrating a first exemplary embodiment of SSB-RO association according to RACH configuration in a communication system.

FIG. 8 is a conceptual diagram illustrating a second exemplary embodiment of SSB-RO association according to RACH configuration in a communication system.

FIG. 9 is a conceptual diagram illustrating an exemplary embodiment of a QCL information transfer process through TCI state configuration and indication in a communication system.

FIG. 10 is a conceptual diagram illustrating an exemplary embodiment of a TCI state activation/deactivation MAC CE in a communication system.

FIG. 11 is a conceptual diagram illustrating an exemplary embodiment of a TCI state indication MAC CE in a communication system.

FIG. 12 is a conceptual diagram illustrating slot configurations according to slot formats in a communication system.

FIG. 13 is a sequence chart illustrating an exemplary embodiment of a UE capability reporting procedure in a communication system.

FIG. 14A is a conceptual diagram for describing a first exemplary embodiment of a user plane protocol stack structure in a communication system.

FIG. 14B is a conceptual diagram for describing a first exemplary embodiment of a control plane protocol stack structure in a communication system.

FIG. 15 is a conceptual diagram illustrating an exemplary embodiment of an IAB network in a communication system.

FIG. 16 is a conceptual diagram illustrating a first exemplary embodiment of a signal transmission/reception method based on a wireless repeater in a communication system.

FIG. 17 is a conceptual diagram illustrating a first exemplary embodiment of a user plane and a control plane in a communication system including a wireless repeater.

FIG. 18A is a conceptual diagrams illustrating a second exemplary embodiment of a user plane in a communication system including a wireless repeater.

FIG. 18B is a conceptual diagrams illustrating a second exemplary embodiment of a control plane in a communication system including a wireless repeater.

FIG. 19 is a conceptual diagram illustrating exemplary embodiments of a DL/UL pattern region.

FIGS. 20A and 20B are conceptual diagrams for describing a first exemplary embodiment of a wireless repeater in a communication system.

FIG. 21 is a conceptual diagram for describing a first exemplary embodiment of a wireless repeater configuration in a communication system.

FIG. 22 is a conceptual diagram for describing a second exemplary embodiment of a wireless repeater configuration in a communication system.

FIG. 23 is a conceptual diagram for describing a third exemplary embodiment of a wireless repeater configuration in a communication system.

FIG. 24 is a conceptual diagram for describing a first exemplary embodiment of a wireless repeater transmission power control method.

FIG. 25 is a conceptual diagram for describing a second exemplary embodiment of a wireless repeater transmission power control method.

FIG. 26 is a conceptual diagram for describing a third exemplary embodiment of a wireless repeater transmission power control method.

FIG. 27 is a conceptual diagram for describing a fourth exemplary embodiment of a wireless repeater transmission power control method.

FIG. 28 is a block diagram illustrating an exemplary embodiment of a communication node constituting a communication system.

### BEST MODE OF THE INVENTION

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g., 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

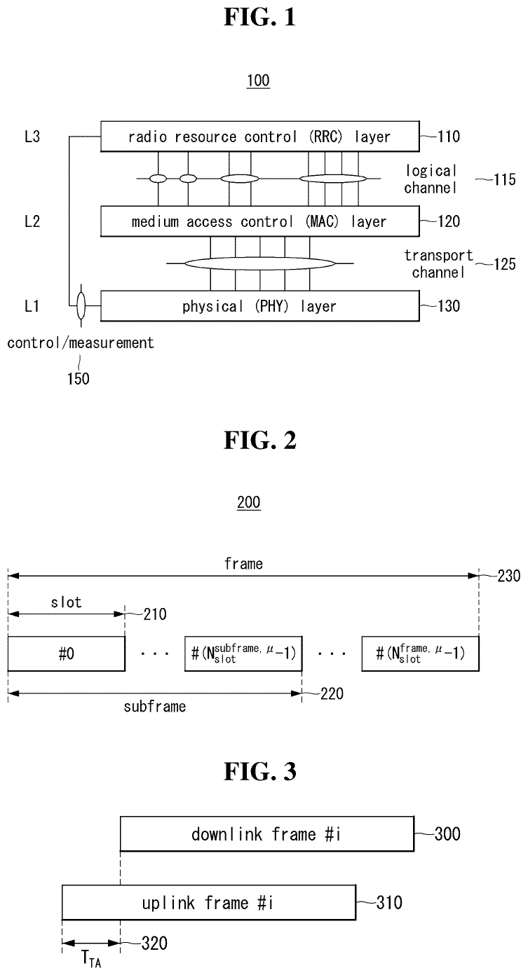

FIG. 1 is a conceptual diagram illustrating an exemplary embodiment of a radio interface protocol structure in a communication system.

Referring to FIG. 1, an exemplary embodiment of a radio interface protocol structure 100 of a communication system may be configured to include a radio resource control (RRC) layer 110, a medium access control (MAC) layer 120, a physical (PHY) layer 130, and the like. An exemplary embodiment of the radio interface protocol structure 100 shown in FIG. 1 may correspond to various exemplary embodiments of interfaces such as an interface between a terminal and a base station, an interface between an IAB-node distributed unit (IAB-DU) and an IAB-node mobile terminal (IAB-MT) of an integrated access backhaul (IAB) network, an interface between an IAB-DU and a lower node, an interface between an IAB-MT and an upper node, an interface between a plurality of terminals, and the like.

In the vicinity of the PHY layer 130, the RRC layer 110, and the MAC layer 120, and the like may be disposed above the PHY layer 130. For example, the MAC layer 120 may be disposed above the PHY layer 130. The RRC layer 110 may be disposed above the MAC layer 120.

The MAC layer 120 may be connected to a higher layer (e.g., RRC layer 110) through logical channels 115. The PHY layer 130 may be connected to the higher MAC layer 120 through transport channels 125. The PHY layer 130 may transmit and receive control information or measurement information 150 to and from the RRC layer 110.

The PHY layer 130 may be referred to as a ‘layer 1’ or ‘L1’. The MAC layer 120 may be referred to as a ‘layer 2’ or ‘L2’. The RRC layer 110 may be referred to as a ‘layer 3’ or ‘L3’. The RRC layer 110 and the MAC layer 120 may be collectively referred to as the ‘higher layer’.

In the present disclosure, ‘L1 signaling’ refers to signaling such as downlink control information (DCI) transmitted on a physical downlink control channel (PDCCH), uplink control information (UCI) transmitted on a physical uplink control channel (PUCCH), and sidelink control information (SCI) transmitted on a physical sidelink control channel (PSCCH), which are channels of the PHY layer 130. Similarly, in the present disclosure, ‘higher layer signaling’ may include L2 signaling transmitted through a MAC control element (CE), L3 signaling transmitted through RRC signaling, and the like. Although omitted in FIG. 1 for convenience of description, information that can be included in an interface between base stations, or an interface (e.g., F1, next generation (NG) interfaces, etc.) between base station components such as a distributed unit (DU) and a central unit (CU) may also be collectively referred to as higher layer signaling as well as the L2 signaling or L3 signaling.

In a communication system to which the 5G communication technology, etc. is applied, one or more of numerologies of Table 1 may be used in accordance with various purposes, such as inter-carrier interference (ICI) reduction according to frequency band characteristics, latency reduction according to service characteristics, and the like.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, |
| | | Extended |
| 3 | 120 | Normal |
| 4 | 240 | Normal |

Table 1 is merely an example for the convenience of description, and exemplary embodiments of the numerologies used in the communication system may not be limited thereto. Each numerology μ may correspond to information of a subcarrier spacing (SCS) Δf and a cyclic prefix (CP). The terminal may identify a numerology μ and a CP value applied to a downlink bandwidth part (BWP) or an uplink BWP based on higher layer parameters such as subcarrierSpacing, cyclicPrefix, and/or the like.

FIG. 2 is a conceptual diagram illustrating an exemplary embodiment of time resources in which radio signals are transmitted in a communication system.

Referring to FIG. 2, time resources in which radio signals are transmitted in a communication system 200 may be represented with a frame 220 comprising one or more

$$( {N}_{slot}^{frame , μ} / {N}_{slot}^{subframe , μ} )$$

subframes, a subframe 220 comprising one or more

$$( {N}_{slot}^{subframe , μ} )$$

slots, and a slot 210 comprising 14

$$( {N}_{symb}^{slot} ) OFDM$$

symbols. In this case, according to a configured numerology, as the values of

$${N}_{symb}^{slot} , {N}_{slot}^{subframe , μ} , and {N}_{slot}^{frame , μ} ,$$

values according to Table 2 below may be used in case of a normal CP, and values according to Table 3 below may be used in case of an extended CP. The OFDM symbols included within one slot may be classified into ‘downlink’, ‘flexible’, or ‘uplink’ by higher layer signaling or a combination of higher layer signaling and L1 signaling.

TABLE 2

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 3

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

In the 5G NR communication system, the frame 230 may have a length of 10 ms, and the subframe 220 may have a length of 1 ms. Each frame 230 may be divided into two half-frames having the same length, and the first half-frame (i.e., half-frame 0) may be composed of subframes #0 to #4, and the second half-frame (i.e., half-frame 1) may be composed of subframes #5 to #9. One carrier may include a set of frames for uplink (i.e., uplink frames) and a set of frames for downlink (i.e., downlink frames).

FIG. 3 is a conceptual diagram illustrating a time difference between a reception timing of an i-th downlink frame and a transmission timing of an i-th uplink frame in an exemplary embodiment of a communication system.

Referring to FIG. 3, a time difference between a reception timing of an i-th downlink frame 300 and a transmission timing of an i-th uplink frame 310 may be a TTA 320. Accordingly, the terminal may start transmission of the uplink frame #i 310 at a time earlier by TTA compared to the reception timing of the downlink frame #i 300. TTA may be referred to as a timing advance or timing adjustment TA. The base station may instruct the terminal to change a value of TTA through higher layer signaling or L1 signaling, and may configure the terminal to apply TTA in a manner defined as T_{TA}=(N_{TA}+N_{TA,offset})T_{c}. In the case of 5G NR, T_{c} may be defined as

$${T}_{c} = \frac{1}{( Δ {f}_{max} \cdot {N}_{f} )} , Δ {f}_{max}$$

may be defined as Δfₘₐₓ=480 kHz, N_{f} may be defined as N_{f}=4096, N_{TA,offset} may be a value set by L3 signaling, and N_{TA} may be a value determined by Equation 1 below by a value T_{A} indicated by L2 signaling.

$${N}_{TA} = \{ \begin{matrix}{T}_{A} \cdot 16 \cdot \frac{64}{{2}^{μ}} ( for random access response ) \\ {N}_{TA\_old} + ( ( {T}_{A} - 31 ) \cdot 16 \cdot 64 / {2}^{μ} ) ( for other cases )\end{matrix} \qquad [ Equation 1 ]$$

Here, the description on N_{TA,offset} and N_{TA} may be an example for a specific situation, and various other options may exist, but in order not to obscure the gist of the description, all possible cases may not be listed in the present disclosure.

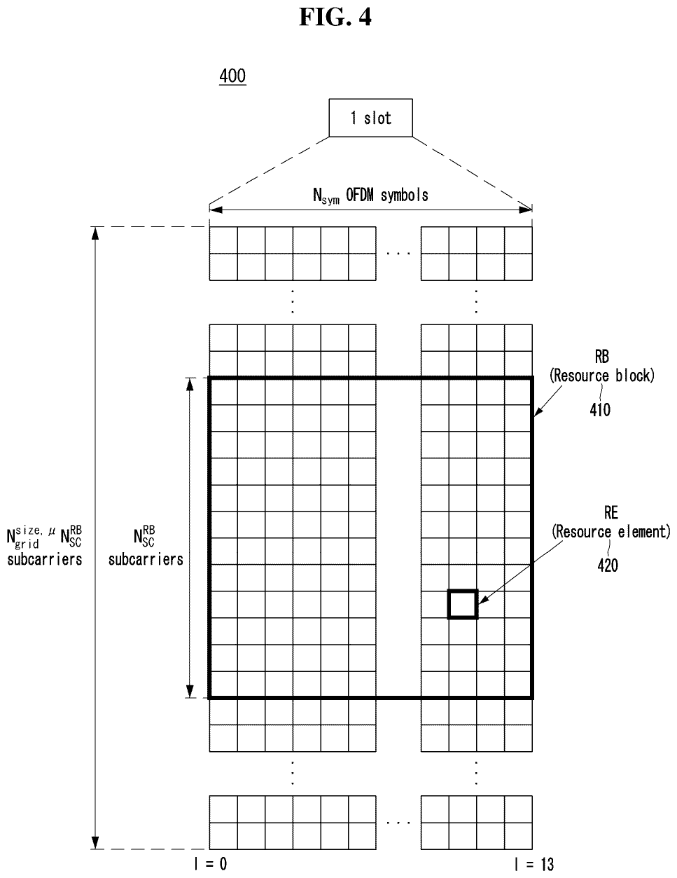

FIG. 4 is a conceptual diagram illustrating an exemplary embodiment of a time/frequency resource grid of a communication system.

Referring to FIG. 4, a time/frequency resource grid 400 of a communication system may have

$${N}_{grid}^{size , μ} {N}_{sc}^{RB}$$

subcarriers and

$${N}_{slot}^{subframe , μ} OFDMs .$$

The resource grid may be defined for each numerology and each carrier. In this case,

$${N}_{grid}^{start , μ}$$

may mean a position of a common resource block (CRB) indicated by higher layer signaling.

$${N}_{grid}^{size , μ}$$

may mean the number of resource blocks (RBs) starting from the CRB, that is, a carrier bandwidth.

$${N}_{grid}^{start , μ} and / or {N}_{grid}^{size , μ}$$

may have different values for each link direction (e.g., uplink, downlink, or sidelink) or for each numerology μ. Here, the numerology may be referred to by other terms, such as a SCS configuration, if necessary.

Each element in the resource grid for an antenna port p and a SCS configuration μ may be referred to as a resource element (RE) 420, and may be uniquely defined for each position (k, l)_{p,μ}. In this case, k may be a frequency axis index, and l may indicate a symbol position on the time axis. RE(k, l)_{p,μ} may correspond to a physical resource used to transmit a physical channel or a signal complex value

$${a}_{k , l}^{( p , μ )} .$$

One RB 410 may be defined as consecutive

$${N}_{sc}^{RB} = 12$$

subcarriers on the frequency axis.

The 5G NR communication system has introduced the concept of BWPs in order to reduce high implementation complexity and power consumption of terminals due to the widened carrier bandwidth compared to the 3G/4G communication system. One BWP may be composed of contiguous CRBs, a starting RB position

$${N}_{BWP , i}^{start , μ}$$

of the BWP and the number

$${N}_{BWP , i}^{size , μ}$$

of RBs constituting the BWP may satisfy Equations 2 and 3.

$${N}_{grid , x}^{start , μ} \leq {N}_{BWP , i}^{start , μ} < {N}_{grid , x}^{start , μ} + {N}_{grid , x}^{size , μ} \qquad [ Equation 2 ]$$

$${N}_{grid , x}^{start , μ} < {N}_{BWP , i}^{start , μ} + {N}_{BWP , i}^{size , μ} \leq {N}_{grid , x}^{start , μ} + {N}_{grid , x}^{size , μ} \qquad [ Equation 3 ]$$

Up to four downlink BWPs within one component carrier (CC) may be configured for one terminal, and only one downlink BWP may be activated at a time. The terminal may not receive a physical downlink shared channel (PDSCH), a physical downlink control channel (PDCCH), a channel state information reference signal (CSI-RS), or the like outside the activated BWP.

Up to four uplink BWPs within one CC may be configured for one terminal, and only one uplink BWP may be activated at a time. The terminal may not transmit a physical uplink shared channel (PUSCH), a physical uplink control channel (PUCCH), a sounding reference signal (SRS), or the like outside the activated BWP.

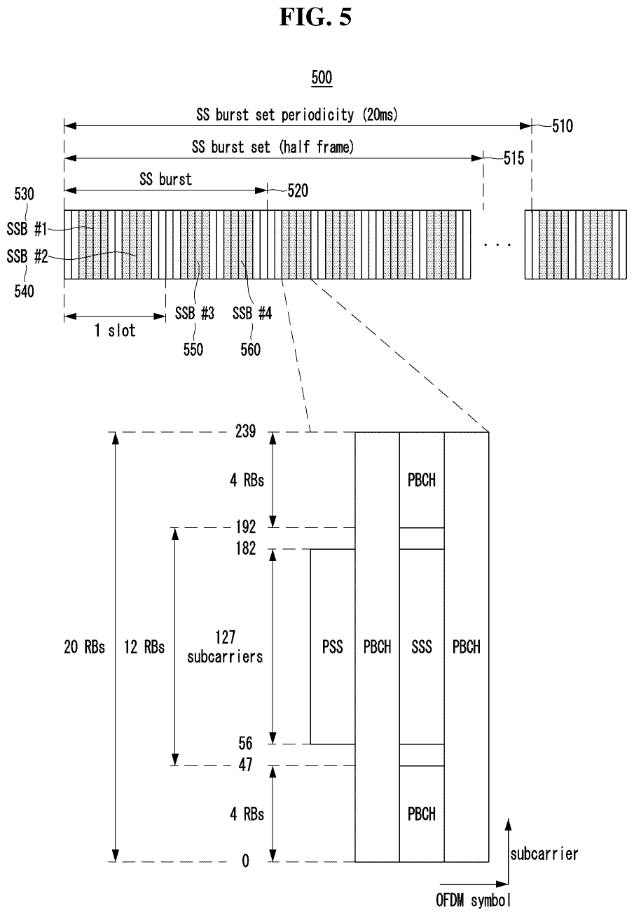

FIG. 5 is a conceptual diagram illustrating an exemplary embodiment of a synchronization signal and physical broadcast channel (SS/PBCH) block or synchronization signal block (SSB) of a communication system.

Referring to FIG. 5, an SS/PBCH block 500 of a communication system may be configured with a primary synchronization signal (PSS) transmitted in 127 subcarriers in the middle of a first OFDM symbol, a secondary synchronization signal (SSS) transmitted in 127 subcarriers in the middle of a third OFDM symbol, and a physical broadcast channel (PBCH) transmitted in second, third, and fourth OFDM symbols. The PBCH occupying the widest bandwidth may be transmitted over 20 RBs, which may be 3.6 MHz based on 15 kHz SCS. The base station transmits one SSB by applying the same beam. When the number of base station antennas increases or it is necessary to operate multiple beams such as applying one or more analog beams for high frequency support, the base station may support a multi-beam operation by transmitting multiple SSBs. Here, the term ‘beam’ may be expressed in various terms such as a transmission precoding or a spatial transmission (TX) filter when applied in practice. However, in order not to obscure the gist of the description, ‘beam’ is used hereinafter as a unified term.

For example, the base station may transmit a plurality of SSBs 530, 540, 550, and 560 to represent a plurality of beams (e.g., beam #1, beam #2, beam #3, beam #4). In this case, it may be possible that one or more SSBs are transmitted within one slot according to a pattern predetermined according to each numerology. The SSBs 530, 540, 550, and 560 to which different beams are applied may be bundled into one set by being included in an SS burst 520. The terminal may assume a half-frame window having a length of 5 ms at the time of monitoring SSBs. An SS burst set 515 configured by higher layer signaling within a half-frame may include one or more SS bursts 520. If RRC configuration values are unknown or unavailable when performing initial access (IA), the terminal may receive or measure the SSBs assuming that a periodicity of the SS burst set 510 is 20 ms. As an example, the terminal may receive SSB(s) with reference to SSB configuration information identical or similar to that shown in Table 4.

TABLE 4

| | |
|---|---|
| MIB ::= | SEQUENCE { |

```
  systemFrameNumber
  subCarrierSpacingCommon
```

| | |
|---|---|
| ssb-SubcarrierOffset | // SSB subcarrier offset (0~15) |

```
  dmrs-TypeA-Position
  pdcch-ConfigSIB1
  cellBarred
  intraFreqReselection
  spare
}
```

| | |
|---|---|
| MeasObjectNR ::= | SEQUENCE { |
| ssbFrequency | // Absolute Radio Frequency Channel Number (ARFCN) of SSB |
| ssbSubcarrierSpacing | // Numerology of SSB |

smtc1

| | |
|---|---|
| | // first SSB measurement timing configuration (SMTC) configured with reference to SSB-MTC |
| smtc2 | // Second SMTC configured with reference to SSB-MTC |

```
  ...
  ...
}
```

| | |
|---|---|
| SSB-Index | // SSB index within SS-burst |
| SSB-MTC ::= | SEQUENCE { |
| | // timing occasion configuration for SSBs to be measured by terminal |
| periodicity AndOffset | CHOICE { |
| sf5 | // offset when a SSB reception window has a legnth of 5 subframes |
| sf10 | // offset when a SSB reception window has a legnth of 10 subframes |
| sf20 | // offset when a SSB reception window has a legnth of 20 subframes |
| sf40 | // offset when a SSB reception window has a legnth of 40 subframes |
| sf80 | // offset when a SSB reception window has a legnth of 80 subframes |
| sf160 | // offset when a SSB reception window has a legnth of 160 subframes |

},

| | |
|---|---|
| duration | // a lengh of a SSB recepion window (number of subframes) |

}

| | |
|---|---|
| SSB-MTC2 ::= | SEQUENCE { |
| pci-List | // physical cell IDs (PCIs) following the SMTC configuration |
| periodicity | // SMTC periodicity (number of subframes) |

}

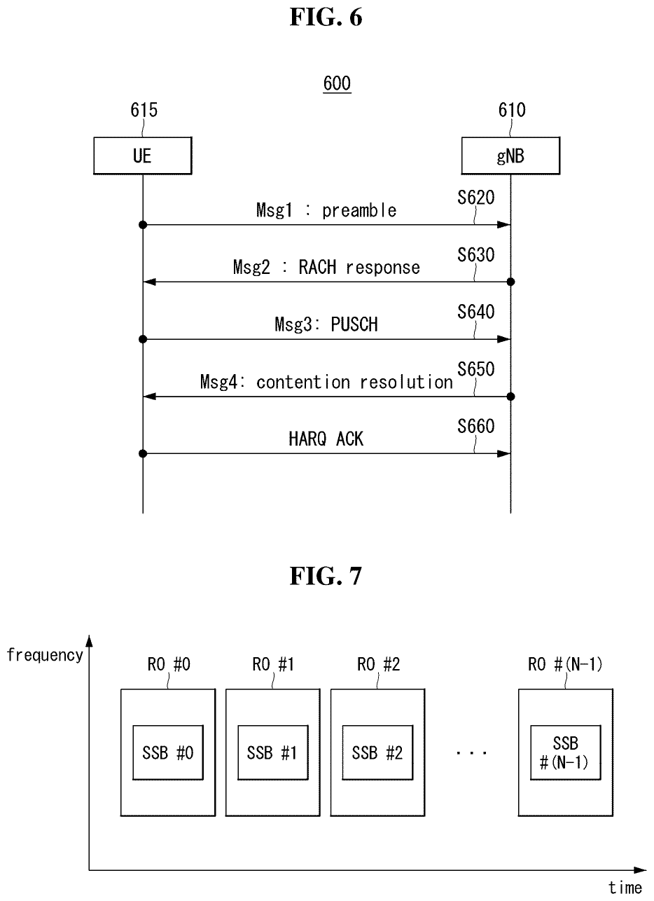

FIG. 6 is a sequence chart illustrating an exemplary embodiment of a random access procedure in a communication system.

Referring to FIG. 6, in a random access procedure of a communication system 600, a terminal 615 may transmit a physical random access channel (PRACH) preamble, and the PRACH preamble may be referred to as ‘Msg1’ (S620). Through a transmission of the PRACH preamble, random access-radio network temporary identifier (RA-RNTI) may be determined. In this case, the RA-RNTI may be calculated by Equation 4.

$$RA - RNTI = 1 + s\_id + 14 \times t\_id + 14 \times 80 \times f\_id + 14 \times 80 \times 8 \times ul\_carrier \_id \qquad [ Equation 4 ]$$

In Equation 4, s_id may be an index of a first OFDM symbol of a corresponding PRACH occasion (e.g., 0≤s_id<14), t_id may be an index of a first slot of the PRACH occasion within a system frame (e.g., 0≤t_id<80), f_id may be an index of the PRACH occasion in the time domain (e.g., 0≤f_id<8), and ul_carrier_id may be a value according to a uplink carrier type used for the preamble transmission (e.g., 0 indicates a regular uplink carrier, 1 indicates a supplementary uplink carrier).

Before the terminal transmits the PRACH preamble, the terminal may have at least part of the following information by receiving system information from the base station on a PBCH or receiving RRC signaling from the base station.
PRACH preamble format
Time/frequency resource information for RACH transmission
Index for a logical root sequence table
Cyclic shift NCS
Set type (unrestricted, restricted set A, restricted set B)

Referring again to FIG. 6, as a second procedure, the base station may provide a random access response (RAR) to the terminal, which may be referred to as ‘Msg2’ (S630). Particularly, the base station may calculate an RA-RNTI based on Equation 4 when the base station receives the PRACH preamble from the terminal in the step S620, and may transmit a DCI by using the RA-RNTI for scrambling. The terminal may monitor a PDCCH scrambled with the RA-RNTI in a period included in a RACH response window configured by the higher layer in a type 1 PDCCH common search space (CSS). The terminal may receive the PDCCH (or the DCI transmitted from the base station through the PDCCH), and may decode the PDCCH (or the DCI). If the terminal successfully decodes the PDCCH (or the DCI), the terminal may decode a PDSCH including the RAR transmitted from the base station in the step S630. If the terminal succeeds in decoding the RAR, the terminal may identify whether an RA preamble identifier (RAPID) in the RAR matches a RAPID pre-allocated to the terminal.

As a third procedure, the terminal may transmit a PUSCH to the base station, which may be referred to as ‘Msg3’ (S640). To this end, the terminal may determine whether to apply a transform precoding to transmission of the PUSCH (i.e., whether to apply discrete Fourier transform (DFT)-s-OFDM-based transmission or OFDM-based transmission) based on a higher layer parameter (e.g., msg3-transformPrecoding). Also, the terminal may determine a SCS to be used for transmission of the PUSCH according to a higher layer parameter (e.g., msg3-scs). In this case, the PUSCH of Msg3 may be transmitted through a serving cell to which the PRACH has been transmitted.

As a fourth procedure, the base station may transmit a contention resolution message to the terminal, which may be referred to as ‘Msg4’ (S650). The terminal may start a timer for receiving the contention resolution message, and may monitor a PDCCH scrambled with a temporary cell-RNTI (TC-RNTI) in the type 1 PDCCH CSS until the timer expires. If the terminal successfully decodes the PDCCH, the terminal may decode a corresponding PDSCH including a MAC CE, and set the TC-RNTI as a cell-RNTI (C-RNTI). After successfully decoding the Msg4, the terminal may report a hybrid automatic repeat request (HARQ) positive-acknowledgement (ACK) thereto to the base station, and may report whether the RACH procedure is successful to the base station (S660).

The RACH occasion (RO) may mean a time and frequency resource specified for reception of a RACH preamble, and the terminal may use the RO for PRACH transmission. As described above, in the 5G NR, multiple SSBs may be associated with different beams for the multi-beam operation, and the terminal may measure the multiple SSBs, and select an optimal SSB (i.e., optimal beam) based on one of various schemes such as a reference signal received power (RSRP), reference signal received quality (RSRQ), signal-to-noise ratio (SNR), signal-to-noise/interference ratio (SNIR), or the like. Thereafter, the terminal may determine a beam (i.e., TX spatial filter) to be used for PRACH transmission based on the beam (i.e., RX spatial filter) used when receiving the optimal SSB. In this case, a relationship between SSB(s) and RO(s) may be established for the purpose of allowing the base station or the network to know which SSB (i.e., beam) the terminal has selected. Through such the relationship, the base station may know the SSB (i.e., beam) selected by the terminal based on the RO in which the terminal has transmitted the PRACH. For example, the relationship between SSB(s) and RO(s) may be determined with reference to the higher layer configurations identical or similar to those shown in Table 5.

TABLE 5

| | |
|---|---|
| RACH-ConfigCommon ::= | SEQUENCE { |
| rach-ConfigGeneric | // set of RACH parameters |
| totalNumberOfRA-Preambles | // the total number of RACH preambles (1~63) |

ssb-perRACH-OccasionAndCB-PreamblesPerSSB CHOICE {

| | |
|---|---|
| oneEighth | // The number of preambles per SSB when one SSB is associated with eight ROs |
| oneFourth | // The number of preambles per SSB when one SSB is associated with four ROs |
| oneHalf | // The number of preambles per SSB when one SSB is associated with two ROs |
| one | // The number of preambles per SSB when one SSB is associated with one RO |
| two | // The number of preambles per SSB when two SSBs are associated with one RO |
| four | // The number of preambles per SSB when four SSBs are associated with one RO |
| eight | // The number of preambles per SSB when eigth SSBs are associated with one RO |
| sixteen | // The number of preambles per SSB when sixteen SSBs are associated with one RO |

}

| | |
|---|---|
| groupBconfigured | SEQUENCE { |
| ra-Msg3SizeGroupA | // The size of a transport block fro contention-based RA of Group A |
| messagePowerOffsetGroupB | // Threshold for preamble selection |
| numberOfRA-PreamblesGroupA | // The number of CB preambles per SSB of Group A |

}

| | |
|---|---|
| ra-ContentionResolutionTimer | // Initial value of a contention resolution timer |
| rsrp-ThresholdSSB | // Threshold for selection of an SSB and an associated RACH resource |
| rsrp-ThresholdSSB-SUL | // Threshold for selection of an SSB and an associated RACH resource in SUL |
| prach-RootSequenceIndex | CHOICE { // RACH root sequence index |

```
    l839
    l139
  },
```

| | |
|---|---|
| msg1-SubcarrierSpacing | // SCS for Msg1 transmission |
| restrictedSetConfig | // one of {unrestricted, restricted set A, restricted set B} |
| msg3-transformPrecoder | // whether to apply transform precoding in transmisison of Msg3 |

...
}

| | |
|---|---|
| RACH-ConfigGeneric ::= | SEQUENCE { |
| prach-ConfigurationIndex | // indicates a preamble format, etc. |
| msg1-FDM | // The number of ROs FDMed at a time |
| msg1-FrequencyStart | // frequnency-axis offset of the lowest RO with reference to PRB 0 |
| zeroCorrelationZoneConfig | // N-CS configuration |
| preambleReceivedTargetPower | // Target power level at a network receiving node |

```
    preambleTransMax
        // The maximum number of RA preambe transmissions performed unitl declaration of an RA failure
```

| | |
|---|---|
| powerRampingStep | // Power ramping step |
| ra-ResponseWindow | // Msg2 (RAR) window length (number of slots) |

...,
}

FIG. 7 is a conceptual diagram illustrating a first exemplary embodiment of SSB-RO association according to RACH configuration in a communication system.

Referring to FIG. 7, in an SSB-RO mapping relation according to the RACH configurations, in a certain frequency band, N SSBs 710-1 to 710-n having time resources which are separated from each other may be mapped to ROs 720-i to 720-n having time resources which are separated from each other on a one-to-one basis. For example, if a higher layer parameter msg1-FDM is set to 1 (i.e., msg1-FDM=one) and a higher layer parameter ssb-perRACH-OccasionAndCB-PreamblesPerSSB is set to 1 (e.g., ssb-perRACH-OccasionAndCB-PreamblesPerSSB=one), the N different SSBs 710-1 to 710-n may be mapped to the N different ROs 720-1 to 720-n on a one-to-one basis.

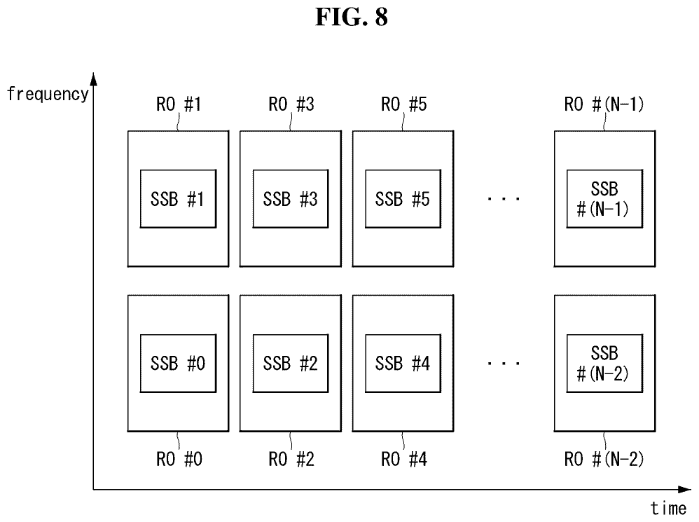

FIG. 8 is a conceptual diagram illustrating a second exemplary embodiment of SSB-RO association according to RACH configuration in a communication system.

Referring to FIG. 8, in an SSB-RO mapping relation according to the RACH configurations, in a first frequency band, SSBs 810-1, 810-3, 810-5, . . . , and 810-(n−1) having time resources which are separated from each other may be mapped to ROs 820-1, 820-3, 820-5, . . . , and 820-(n−1) having time resources which are separated from each other on a one-to-one basis. In addition, in a second frequency band, SSBs 810-2, 810-4, 810-6, . . . , and 810-n having time resources which are separated from each other may be mapped to ROs 820-2, 820-4, 820-6, . . . , and 820-n) having time resources which are separated from each other on a one-to-one basis. For example, if the higher layer parameter msg1-FDM is set to 2 (i.e., msg1-FDM=two), and higher layer parameter ssb-perRACH-OccasionAndCB-PreamblesPerSSB is set to 2 (e.g., ssb-perRACH-OccasionAndCB-PreamblesPerSSB=two), the N different SSBs 810-1 to 810-n may be mapped to the N different ROs 820-1 to 820-n which are frequency division multiplexed (FDMed) in a frequency domain, on a one-to-one basis.

Meanwhile, the 5G NR communication system may support DCI formats shown in Table 6 based on Release-16.

TABLE 6

| DCI format | Usage |
|---|---|
| 0_0 | Used for scheduling a PUSCH within one cell |
| 0_1 | Used for scheduling one or more PUSCHs within one cell, |
| | or indicating downlink feedback information for a |
| | configured grant (CG) PUSCH (i.e., CG-DFI) |
| 0_2 | Used for scheduling a PUSCH within one cell |
| 1_0 | Used for scheduling a PDSCH within one cell |
| 1_1 | Used for scheduling a PDSCH within one cell or triggering |
| | a one-shot HARQ-ACK codebook feedback |
| 1_2 | Used for scheduling a PDSCH within one cell |
| 2_0 | Used for notifying a slot format, an available RB set, |
| | a channel occupancy time (COT) duration, and search |
| | space set group switching to a UE group |
| 2_1 | Used for notifying PRB(s) and OFDM symbol(s) assumed |
| | not to be intended to be used for transmission |
| | to a UE group |
| 2_2 | Used for transmission of a transmission power control |
| | (TPC) for a PUCCH and a PUSCH |
| 2_3 | Used for transmission of a TPC command group for |
| | SRS transmission by one or more UEs |
| 2_4 | Used for a UE to notify PRB(s) and OFDM symbol(s) |
| | for which UL transmission from the UE is cancelled |
| | to a UE group |
| 2_5 | Used for notifying availability of soft resources |
| 2_6 | Used for notifying power saving information outside |
| | a DRX active time to one or more UEs |
| 3_0 | Used for NR sidelink scheduling within one cell |
| 3_1 | Used for LTE sidelink scheduling within one cell |

A DCI may include downlink control information for one or more cells, and may be associated with one RNTI. The DCI may be encoded through the order of 1) information element multiplexing, 2) cyclic redundancy check (CRC) addition, 3) channel coding, and 4) rate matching, and decoding may also be performed in consideration of the above steps. In the above description, “a certain DCI is associated with one RNTI” may mean that CRC parity bits of the DCI are scrambled with the RNTI. Referring to Table 6, some DCI may include scheduling information of one or more PUSCHs for a certain cell.

For example, a CRC of the DCI format 0_1 may be scrambled with a C-RNTI, configured scheduling-RNTI (CS-RNTI), semi-persistent CSI RNTI (SP-CSI-RNTI), or modulation coding scheme cell RNTI (MCS-C-RNTI). The DCI format 0_1 may include at least one of the following information.
Identifier for DCI format (1 bit): Indicator indicating a UL DCI format, which is always set to 0 in the case of DCI format 0_1
Carrier indicator (0 or 3 bits): Indicator indicating a CC scheduled by the corresponding DCI
DFI flag (0 or 1 bit): Configured grant downlink feedback information (CG-DFI) indicator
If the DCI format 0_1 is used for CG-DFI indication (when the DFI flag is set to 1), at least one of the following fields may be used:
HARQ-ACK bitmap (16 bits), where the order of mapping HARQ process indexes within the bitmap is that the HARQ process indexes are mapped from the MSB to the LSB of the bitmap in ascending order. For each bit in the bitmap, a value of 1 indicates ACK, and a value of 0 indicates NACK.
TPC command for a scheduled PUSCH (2 bits)
All the remaining bits in the DCI format 0_1 are set to zero
If the DCI format 0_1 is not used for CG-DFI indication (when there is no DFI flag field or DFI flag field is set to 0), at least one of the following fields may be used:
UL/SUL indicator (0 or 1 bit): supplementary UL indicator.
Bandwidth part indicator (0, 1, or 2 bits): Indicator indicating a BWP to be activated among uplink BWPs configured for the terminal.
Frequency domain resource assignment: Indicator for allocating a frequency domain resource.
Time domain resource assignment: Indicator for allocating a time domain resource.
Frequency hopping flag (0 or 1 bit): Frequency axis hopping indicator
Modulation and coding scheme (5 bits)
New data indicator (NDI): Indicator indicating whether allocated data is new data or retransmission data.
Redundancy version (RV): Indicator indicating an RV value when channel coding is applied to allocated data
HARQ process number (4 bits): Indicator indicating a HARQ process to be allocated to scheduled data
TPC command for a scheduled PUSCH (2 bits): TPC indicator
SRS resource indicator: Aperiodic SRS resource selection indicator
Precoding information and number of layers: Indicator indicating precoding and the number of transport layers to be used in PUSCH transmission
Antenna ports: Indicator for uplink antenna ports to be used for PUSCH transmission
SRS request: Indicator indicating whether to transmit aperiodic SRS
CSI request: Indicator indicating whether and how to report channel state information
PTRS-DMRS association: Indicator indicating a relationship between an uplink phase-noise tracking reference signal (PTRS) antenna port and a demodulation reference signal (DMRS) antenna port
DMRS sequence initialization: Indicator for a DMRS sequence initialization value during OFDM-based uplink transmission
UL-SCH indicator: Indicator indicating whether or not an uplink shared channel (UL-SCH) is included in a PUSCH (a PUSCH that does not include a UL-SCH needs to include CSI)
Open-loop power control parameter set indication: Indicator indicating a set of open-loop power control (OPLC) parameter set
Priority indicator: Uplink transmission priority indicator.
Invalid symbol pattern indicator: Indicator indicating whether to apply an invalid symbol pattern configured by a higher layer

As another example, a CRC of the DCI format 11 may be scrambled with a C-RNTI, CS-RNTI, or MCS-C-RNTI, and the DCI format 1_1 may include at least one of the following information.
Identifier for DCI format (1 bit): Indicator indicating a DL DCI format, which is always set to 1 in the case of DCI format 1_1
Carrier indicator (0 or 3 bits): Indicator indicating a CC scheduled by the corresponding DCI
Bandwidth part indicator (0, 1, or 2 bits): Indicator indicating a BWP to be activated among downlink BWPs configured for the terminal
Frequency domain resource assignment: Indicator for allocating a frequency domain resource
Time domain resource assignment: Indicator for allocating a time domain resource
PRB bundling size indicator: Indicator indicating a type (i.e., static or dynamic) and a size of PRB bundling
Rate matching indicator: Indicator indicating a rate matching pattern configured by a higher layer
ZP CSI-RS trigger: Indicator for applying aperiodic zero-power (ZP) CSI-RS
‘modulation and coding scheme’, ‘new data indicator’, and ‘redundancy version’ fields for a transport block 1
‘modulation and coding scheme’, ‘new data indicator’, and ‘redundancy version’ fields for a transport block 2
HARQ process number: Indicator indicating a HARQ process to be allocated to scheduled data
Downlink assignment index: DAI indicator for HARQ-ACK codebook generation in TDD operation.
TPC command for a scheduled PUCCH: Power control indicator for PUCCH transmission.
PUCCH resource indicator: Indicator indicating a PUCCH resource for transmitting HARQ-ACK information for an allocated PDSCH or a predetermined PDSCH set
PDSCH-to-HARQ_feedback timing indicator: Indicator indicating a time axis offset between the allocated PDSCH and the PUCCH
Antenna port(s): Indicator indicating antenna ports to be used for PDSCH transmission/reception
Transmission configuration indication: Indicator indicating transmission configuration information (TCI) to be used for PDSCH transmission and reception
SRS request: Indicator indicating whether to transmit aperiodic SRS
DMRS sequence initialization: Indicator for a DMRS sequence initialization value used for PDSCH transmission and reception
Priority indicator: PDSCH reception priority indicator

As another example, certain DCI formats may be used to deliver the same control information to one or more terminals. For example, a CRC of the DCI format 2_3 may be scrambled with a transmit power control-sounding reference signal-RNTI (TPC-SRS-RNTI), and may include at least one of the following information.
Block number 1, Block number 2, . . . , Block number B: Indicators indicating resource regions to which the DCI format 2_3 is applied. A starting part of the block is configured by a higher layer parameter startingBitOfFormat2-3 or startingBitOfFormat2-3SUL-v1530.
When a terminal for which a higher layer parameter srs-TPC-PDCCH-Group is set to type A performs uplink transmission without a PUCCH and PUSCH or uplink transmission in which SRS power control is not tied to PUSCH power control, one block is configured by the higher layer, and the following fields are defined for the block.
SRS request (0 or 2 bits): Aperiodic SRS transmission indicator
TPC command number 1, TPC command number 2, . . . ,TPC command number N: Indicators indicating uplink power control to be applied to a UL carrier indicated by a higher layer parameter cc-IndexInOneCC-Set.
When a terminal for which a higher layer parameter srs-TPC-PDCCH-Group is set to type B performs uplink transmission without a PUCCH and PUSCH or uplink transmission in which SRS power control is not tied to PUSCH power control, one or more blocks may be configured by the higher layer, and the following fields are defined for each block.
SRS request (0 or 2 bits): Aperiodic SRS transmission indicator.
TPC command (2 bits)

As another example, certain DCI formats may be used to deliver the same control information to one or more terminals. For example, a CRC of the DCI format 2_0 may be scrambled with an SFI-RNTI, and may be used for notifying information such as a slot format, a channel occupancy time (COT) duration, an available RB set, a search space set group switching, or the like. Specifically, the DCI format 2_0 may include at least one of the following information.
When a higher layer parameter slotFormatCombToAddModList is configured,
Slot format indicator 1, Slot format indicator 2, . . . , Slot format indicator N
When a higher layer parameter availableRB-SetsToAddModList-r16 is configured,
Available RB set indicator 1, Available RB set indicator 2, . . . , Available RB set indicator N1
When a higher layer parameter co-DurationsPerCellToAddModList-r16 is configured,
COT duration indicator 1, COT duration indicator 2, . . . , COT duration indicator N2
When a higher layer parameter searchSpaceSwitchTriggerToAddModList-r16 is configured,
Search space set group switching flag 1, Search space set group switching flag 2, . . . , Search space set group switching flag M

The size of the DCI format 2_0 may be set by higher layer signaling as one of 0 to 128 bits. For example, the DCI format 2_5 may be used to notify availability of soft-type resources of an IAB node. A CRC of the DCI format 2_5 may be scrambled with an availability indicator-RNTI (AI-RNTI), and may include the following information.
Availability indicator 1, Availability indicator 2, . . . , and Availability indicator N

As the size of DCI format 2_5, one of values less than or equal to 128 bits may be set by higher layer signaling. The terminal may receive configuration information of a CORESET #0 and a search space #0, identical or similar to that shown in Table 7.

TABLE 7

| | |
|---|---|
| PDCCH-ConfigSIB1 ::= | SEQUENCE { |

```
  controlResourceSetZero
  searchSpaceZero
}
```

| | |
|---|---|
| ControlResourceSetZero | // indicates a configuration value (0~15) of a CORESET #0 within an initial BWP |
| SearchSpaceZero | // indicates a configuration value (0~15) of a search space #0 within an initial BWP |

The terminal may refer to the following higher layer configurations for cell-specific PDCCH monitoring, identical or similar to those shown in Tables 8 to 9.

TABLE 8

| | |
|---|---|
| PDCCH-ConfigCommon ::= | SEQUENCE { |

```
  controlResourceSetZero // indicates a configuration value (0~15) of a CORESET #0 within an initial BWP
  commonControlResourceSet
      // configure a common CORESET by referring to CORESET configuration
```

| | |
|---|---|
| searchSpaceZero | // indicates a configuration value (0~15) of a search space #0 within an initial BWP |
| commonSearchSpaceList | // configures a search sapce to be used for cell-specific PDCCH monitoring by |

referring to up to four search space configurations

| | |
|---|---|
| searchSpaceSIB1 | // search space configuration for SIB1 |
| searchSpaceOtherSystemInformation | // search space configuration for SIB2 or other SIBs |
| pagingSearchSpace | // search space configuration for paging |
| ra-SearchSpace | // search space configuration for random access procedure |

...
}

| | |
|---|---|
| ControlResourceSet ::= | SEQUENCE { |
| controlResourceSetId | // CORESET ID (a value other than 0 is used) |
| frequencyDomainResources | // configuration of frequency resources of a CORESET |
| duration | // configuration of a time-axis length (symbols) of a CORESET |
| cce-REG-MappingType | CHOICE { // CCE-to-REG mapping configuration |
| interleaved | SEQUENCE { |

```
      reg-BundleSize
      interleaverSize
      shiftIndex
    },
    nonInterleaved
  },
  precoderGranularity
  tci-StatesPDCCH-ToAddList
```

// indicates a QCL relation possible between a QCL reference RS and a PDCCH DMRS

tci-StatesPDCCH-ToReleaseList

| | |
|---|---|
| tci-PresentInDCI | // indicates whether a TCI field exists within the DCI format 1_1 |
| pdcch-DMRS-ScramblingID | // indicates a scrambling initialization value of a PDCCH DMRS |

...
}

TABLE 9

| | |
|---|---|
| SearchSpace ::= | SEQUENCE { |
| searchSpaceId | // search space ID |
| controlResourceSetId | // CORESET ID associated with the search space |
| monitoringSlotPeriodicityAndOffset | CHOICE { // periodicity and offset of a PDCCH monitoring slot |
| sl1 | // performs PDCCH monitoring in every slot |

...

// (omitted) monitoring offset values when a PDCCH monitoring periodicity is one of 2 to

1280 slots

| | |
|---|---|
| sl2560 | // a monitoring offset value when a PDCCH monitoring periodicity is 2560 slots |

}

| | |
|---|---|
| duration | // the number of slots where a search space exists for each occasion |

```

[symbol]

  monitoringSymbolsWithinSlot
      // a position of a first symbol on which monitoring is to be performed within a PDCCH monitoring slot
```

| | |
|---|---|
| nrofCandidates | SEQUENCE { |
| aggregationLevel1 | // The number of PDCCH candidates in case of aggregation level 1 |
| aggregationLevel2 | // The number of PDCCH candidates in case of aggregation level 2 |
| aggregationLevel4 | // The number of PDCCH candidates in case of aggregation level 4 |
| aggregationLevel8 | // The number of PDCCH candidates in case of aggregation level 8 |
| aggregationLevel16 | // The number of PDCCH candidates in case of aggregation level 16 |

}

| | |
|---|---|
| searchSpaceType | CHOICE { // indicates a search space type (common or UE-specific) and DCI |

formats

| | |
|---|---|
| common | SEQUENCE { |
| dci-Format0-0-AndFormat1-0 | SEQUENCE { |

```
        ...
      }
```

| | |
|---|---|
| dci-Format2-0 | SEQUENCE { |
| nrofCandidates-SFI | SEQUENCE { |

```
          ...
        },
        ...
      }
      dci-Format2-1
      dci-Format2-2
```

| | |
|---|---|
| dci-Format2-3 | SEQUENCE { |

```
        dummy1
        dummy2
      }
    },
```

| | |
|---|---|
| ue-Specific | SEQUENCE { |

```
      dci-Formats
      ...,
    }
  }
}
```

The terminal may refer to the following higher layer configurations for UE-specific PDCCH monitoring, identical or similar to those shown in Table 10.

TABLE 10

| | |
|---|---|
| PDCCH-Config ::= | SEQUENCE { |

```
  controlResourceSetToAddModList
      // At most three CORESETs are configured by referring to CORESET configuration
    controlResourceSetToReleaseList
  searchSpacesToAddModList
      // At most ten search spaces are configured by referring to search space configuration
searchSpacesToReleaseList
```

| | |
|---|---|
| downlinkPreemption | // downlink preemption indicator |
| tpc-PUSCH | // configuraion of reception of a group TPC for PUSCH transmission |
| tpc-PUCCH | // configuration of reception of a group TPC for PUCCH transmission |
| tpc-SRS | // configuration of reception of a group TPC for SRS transmission |

...,
}

The presence of one antenna port may mean a case in which a channel experienced by a symbol transmitted through the corresponding antenna port can be estimated or inferred from a channel experienced by another symbol transmitted through the same antenna port.

“Two different antenna ports are quasi co-located (QCLed)” may mean a case in which large-scale characteristics of a channel experienced by a symbol transmitted through one antenna port can be estimated or inferred from a channel experienced by a symbol transmitted through another antenna port. The large-scale characteristics of the channel may mean at least one of ‘delay spread’, ‘Doppler spread’, ‘Doppler shift’, ‘average gain’, ‘average delay’, and ‘spatial Rx parameters’.

When time/frequency resources of a certain signal (e.g., QCL target RS) are insufficient and large-scale characteristics of a channel cannot be accurately measured with only the corresponding signal, information (i.e., QCL information) on another signal (e.g., QCL reference RS having sufficient time/frequency resources) having large-scale characteristics that can be reused for reception of the corresponding signal (i.e., QCL target RS) may be provided to the terminal to improve the channel measurement performance of the terminal. The NR communication system may support various QCL types as follows.

- QCL-Type A: including {Doppler shift, Doppler spread, average delay,
delay spread}.
- QCL-Type B: including {Doppler shift, Doppler spread}
- QCL-Type C: including {Doppler shift, average delay}
- QCL-Type D: including {Spatial Rx parameters}

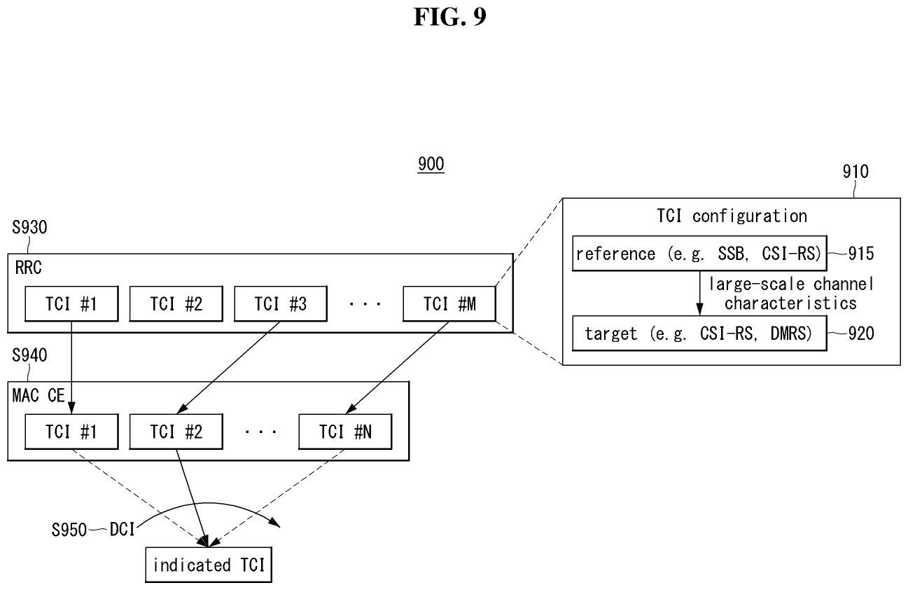

FIG. 9 is a conceptual diagram illustrating an exemplary embodiment of a QCL information transfer process through TCI state configuration and indication in a communication system.

Referring to FIG. 9, in a process of transmitting QCL information through TCI state configuration and indication in a communication system 900, a base station may configure at most M TCI states to a terminal through higher layer (i.e., RRC) signaling, in accordance with a UE capability report and a maximum value (e.g., 4, 8, 64, or 128 depending on a frequency band) defined in a technical specification (S930). In this case, each TCI state configuration 910 may include information on a signal or channel (i.e., QCL reference 915) that provides large-scale channel characteristics to a signal or channel (i.e., QCL target 920) referring to the TCI. One TCI state configuration 910 may include up to two references (i.e., qcl-Type1 and qcl-Type2), the first reference may be one of the QCL-Type A, QCL-Type B, and QCL-type C (i.e., qcl-type1 ∈{QCL-type A, QCL-type B, QCL-type C}), and the second reference may be the QCL-type D if present (i.e., qcl-type 2=QCL-type D).

Allowing the base station to apply all the TCIs configured through the RRC signaling in real time may greatly increase implementation complexity of the terminal, the base station may transmit an activation message for some of the TCIs configured through the RRC signaling to the terminal through L2 signaling such as a MAC CE (5940). The base station may activate a maximum of N (<M) TCIs, and the terminal may receive a dynamic indication only for the activated TCI.

Thereafter, the base station may dynamically indicate to the terminal some of the activated N TCIs through L1 signaling such as a DCI (S950). The terminal may apply QCL information indicated by the corresponding TCI at a predetermined timing after receiving the L1 signaling, and may perform a reception operation for the signal or channel.

The TCI state indication steps including the ‘RRC signaling (S930)’, ‘MAC CE signaling (S940)’, and ‘DCI signaling (S950)’ of FIG. 9 may be partially omitted depending on a type of the QCL target RS. For example, when the QCL target is a PDSCH DMRS, and one or more TCI states are configured through RRC signaling, the base station may indicate the TCI state using all the steps of FIG. 9. However, when the QCL target is a PDSCH DMRS, and a single TCI state is configured through RRC signaling, the MAC CE signaling (S940) and the DCI signaling step (S950) may be omitted. Similarly, when the QCL target is a PDCCH DMRS, the DCI signaling step S940 may be omitted. Specifically, the terminal may obtain configuration information for the TCI states and QCL information with reference to the RRC signaling identical or similar to those shown in Table 11.

TABLE 11

| | |
|---|---|
| TCI-State ::= | SEQUENCE { // TCI configuration (I.1-00) |
| tci-StateId | // TCI state ID |
| qcl-Type1 | // first QCL reference configured by referring to QCL information |
| qcl-Type2 | // second QCL reference configured by referring to QCL information |

...
}

| | |
|---|---|
| QCL-Info ::= | SEQUENCE { |
| cell | // index of a cell in which QCL reference is transmitted |
| bwp-Id | // index of a BWP in which QCL reference is transmitted |
| referenceSignal | CHOICE { |
| csi-rs | // index of a CSI-RS to be referred when QCL reference is a CSI-RS |
| ssb | // index of an SSB to be referred when QCL reference is an SSB |

```
  },
  qcl-Type
  // QCL type to be applied to a QCL target (one of QCL-type A, QCL-type B, QCL-type C, and QCL-type D)
  ...
}
```

The base station may instruct the terminal to activate or deactivate some of the TCI states configured by the RRC signaling through MAC CE signaling, or may instruct the terminal to apply a TCI state indicated by a MAC CE to the QCL target RS. For example, the base station may use the following MAC CE signaling according to the type of the QCL target RS.
TCI state activation/deactivation MAC CE for a UE-specific PDSCH DMRS
TCI state indication MAC CE for a UE-specific PDCCH DMRS
TCI state activation/deactivation MAC CE for an enhanced UE-specific PDSCH DMRS

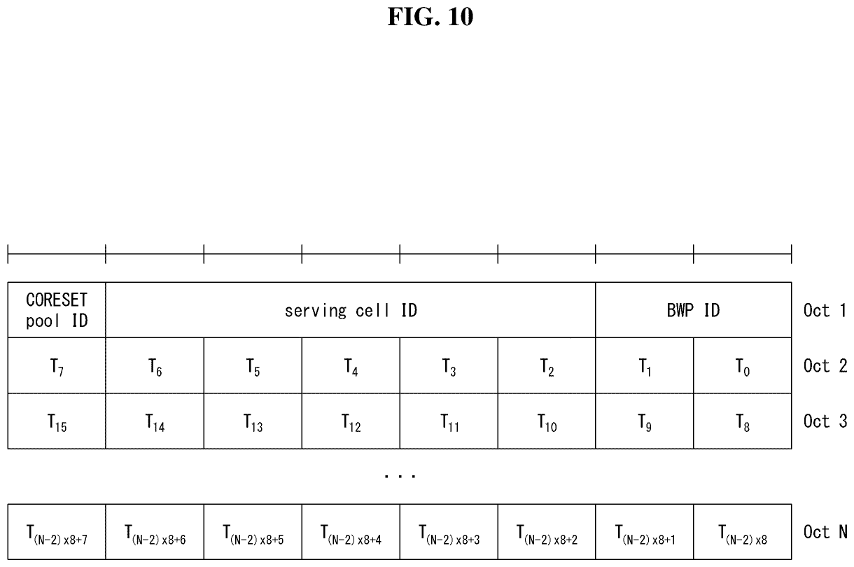

FIG. 10 is a conceptual diagram illustrating an exemplary embodiment of a TCI state activation/deactivation MAC CE in a communication system.

Referring to FIG. 10, a first octet (Oct 1) in a TCI state activation/deactivation MAC CE for a UE-specific PDSCH DMRS may include a COREST pool ID field 1010, a serving cell ID field 1020, and a BWP ID field 1030, and a second octet (Oct 2) to an N-th octet (Oct N) may include Ti fields 1040 indicating TCI state IDs i. The detailed meaning of each field may be as follows, and the sizes thereof may be variable.
Serving cell ID: a serving cell ID to which the MAC CE is applied
BWP ID: BWP ID to which the MAC CE is applied, which indicates a BWP in association with a BWP indication field within the DCI
Ti: indicates a TCI state ID i. When this value is set to 0, it may mean that a TCI state whose TCI state ID is i is deactivated, and when this value is set to 1, it may mean that a TCI state whose TCI state ID is i is activated. The TCI states activated by 1 may be sequentially mapped to TCI indication field code points within the DCI.
CORESET pool ID: If a DCI scheduling a PDSCH is monitored in a CORESET that does not include a higher layer parameter coresetPoolIndex, the field may be ignored. If a DCI scheduling a PDSCH is monitored in a CORESET including the higher layer parameter coresetPoolIndex, Ti indication may be applied only when a value of the CORESET pool ID matches a value of coresetPoolIndex of the CORESET.

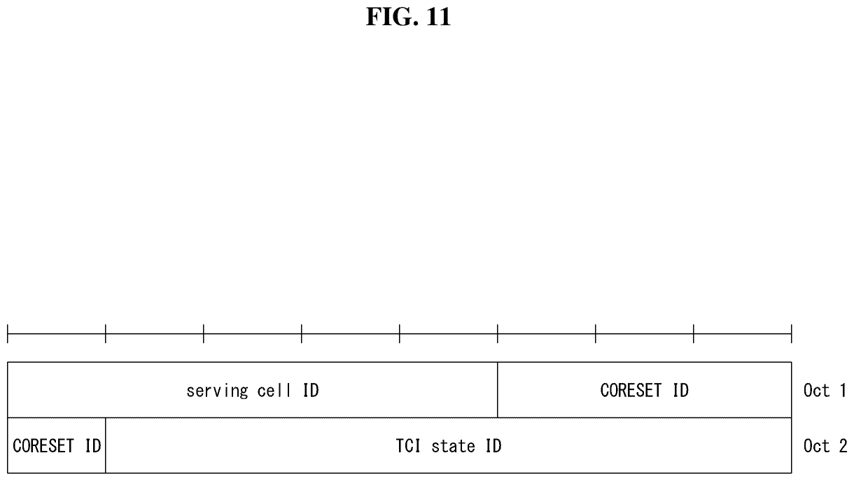

FIG. 11 is a conceptual diagram illustrating an exemplary embodiment of a TCI state indication MAC CE in a communication system.

Referring to FIG. 11, a first octet (Oct 1) in a TCI state activation/deactivation MAC CE for a UE-specific PDSCH DMRS may include a serving cell ID field 1110 and a CORESET ID field 1120, and a second octet (Oct 2) may include a CORESET ID field 1130 and a TCI state ID field 1140. The sizes thereof may be variable.
Serving cell ID: a serving cell ID to which the corresponding MAC CE is applied.
CORESET ID: indicates a CORESET to which the MAC CE is applied. If this value is set to 0, a CORESET configured through controlResourceSetZero may be a CORESET #0.
TCI state ID: means a TCI state ID indicated by the corresponding MAC CE.

The base station may configure spatial relation information to the terminal through higher layer (e.g., RRC) signaling in order to indicate uplink beam information. The spatial relation information may mean a signaling structure for using spatial domain filters used for transmission and reception of a reference RS for spatial TX filters for uplink transmission of a target RS according to the corresponding spatial relation. The spatial reference RS may be a downlink signal such as SSB or CSI-RS, and may also be an uplink signal such as SRS. If the reference RS is a downlink signal, the terminal may use the spatial RX filter values used for receiving the reference RS as spatial TX filter values for transmitting the target RS according to the spatial relation. If the reference RS is an uplink signal, the terminal may use the spatial TX filter values used for transmitting the reference RS as the spatial TX filter values for transmitting the target RS according to the spatial relation.

The signaling structure for the spatial relation information may vary depending on the type of target RS. For example, when the target RS is an SRS, the base station may perform RRC configuration for each SRS resource based on message identical or similar to those shown in Table 12.

TABLE 12

| | |
|---|---|
| SRS-SpatialRelationInfo ::= | SEQUENCE { |
| servingCellId | // index of a serving cell in which a reference RS is transmitted |
| referenceSignal | CHOICE { |
| ssb-Index | // SSB index when a reference RS is SSB |
| csi-RS-Index | // CSI-RS resource index when a reference RS is CSI-RS |
| srs | SEQUENCE { |
| resourceId | // SRS resource index when a reference RS is SRS |
| uplinkBWP | // index of a UL BWP in which SRS is transmitted when a reference RS is SRS |

```
        }
  }
}
```

For example, when the target RS is an SRS, the base station may perform RRC configuration for each SRS resource, identical or similar to those shown in Table 13.

TABLE 13

| | |
|---|---|
| PUCCH-SpatialRelationInfo ::= | SEQUENCE { |
| pucch-SpatialRelationInfold | // spatial relation information ID for PUCCH |
| servingCellId | // index of a serving cell in which a reference RS is transmitted |
| referenceSignal | CHOICE { |
| ssb-Index | // SSB index when a reference RS is SSB |
| csi-RS-Index | // CSI-RS resource index when a reference RS is CSI-RS |
| srs | // specifiy a SRS resource by referring to PUCCH-SRS configuration |

},
pucch-PathlossReferenceRS-Id

| | |
|---|---|
| | // index of a RS resource to be used for measurement of a pathloss of a PUCCH |
| p0-PUCCH-Id | // index of confuring p0 for PUCCH power control |
| closedLoopIndex | // configuration value of closed-loop power control |

}

| | |
|---|---|
| PUCCH-SRS ::= | SEQUENCE { |
| resource | // SRS resource index |
| uplinkBWP | // index of a BWP in which SRS is transmitted |

}

In the 5G NR communication system, a slot format may include downlink symbol(s), uplink symbol(s), and/or flexible symbol(s).

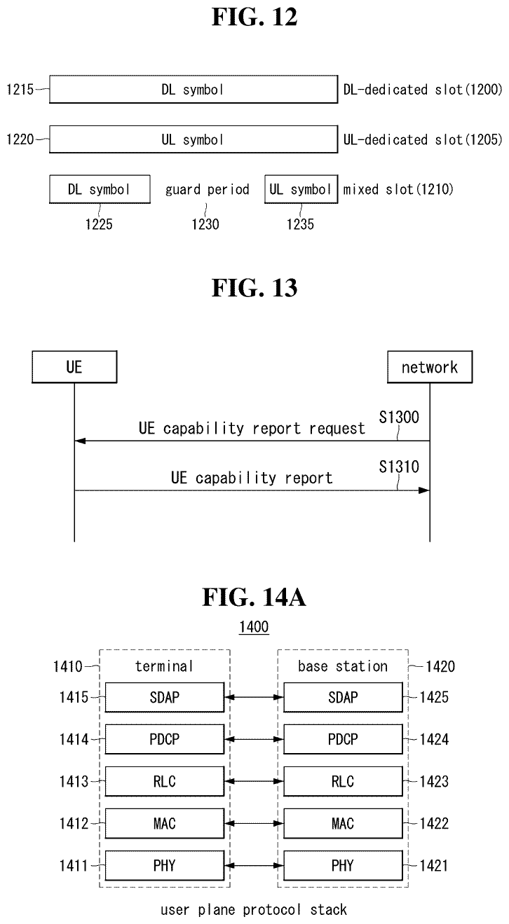

FIG. 12 is a conceptual diagram illustrating slot configurations according to slot formats in a communication system.

Referring to FIG. 12, in slot configurations according to slot formats in a communication system, a downlink dedicated slot 1200 may be a slot in which all symbols within the slot are configured only as downlink symbols 1215 according to a slot format. As another example, an uplink dedicated slot 1205 may be a slot in which all symbols within the slot are configured only as uplink symbols 1220 according to a slot format. As another example, in a downlink/uplink mixed slot 1210, some symbols within the slot may be configured as downlink symbols 1225, and some symbols within the slot may be configured as uplink symbols 1235 according to a slot format. In this case, specific symbols of the mixed slot 1210 including both the uplink and downlink symbols may be configured or indicated as a guard period 1230 for downlink-uplink switching, and the terminal may not perform transmission/reception during the guard period 1230.

In the 5G NR communication system, the base station may configure a ‘slot format’ over one or more slots for each serving cell to the terminal through a higher layer parameter tdd-UL-DL-ConfigurationCommon. In this case, the higher layer parameter tdd-UL-DL-ConfigurationCommon may include or refer to at least one of the following information.
Reference subcarrier spacing: reference numerology pref
Pattern 1: A first pattern.
Pattern 2: A second pattern.

Here, the pattern 1 or pattern 2 may include at least one of the following configurations.
Slot configuration periodicity (i.e., dl-UL-TransmissionPeriodicity): Slot configuration periodicity P expressed in units of msec
Number of downlink dedicated slots (i.e., nrofDownlinkSlots): The number dₛₗₒₜₛ of slots composed only of downlink symbols
Number of downlink symbols (i.e., nrofDownlinkSymbols): The number d_{sym} of downlink symbols
Number of uplink dedicated slots (i.e., nrofUplinkSlots): The number uₛₗₒₜₛ of slots composed only of uplink symbols
Number of uplink symbols (i.e., nrofUplinkSymbols): The number u_{sym} of uplink symbols

The slot configuration periodicity P msec of the first pattern may include S=P·2^{μ}^{_{ref}} slots, and in this case, the numerology may follow μ_{ref}. In addition, among the S slots, the first dₛₗₒₜₛ slots may include only downlink symbols, and the last uₛₗₒₜₛ slots may include only uplink symbols. In this case, d_{sym} symbols after first dₛₗₒₜₛ slots may be downlink symbols. In addition, u_{sym} symbols before last uₛₗₒₜₛ slots may be uplink symbols. The remaining symbols (i.e.,

$$( S - {d}_{slots} - {u}_{slots} ) \cdot {N}_{symb}^{slot} - {d}_{sym} - {u}_{sym} symbols )$$

that are not designated as downlink symbols or uplink symbols in the pattern may be flexible symbols.

If the second pattern is configured and the slot configuration periodicity of the second pattern is P₂, a slot configuration periodicity P+P₂ msec configured with a combination of the first pattern and the second pattern may include first S=P·2^{μ}^{_{ref}} slots and second S₂=P₂·2^{μ}^{_{ref}} slots. In this case, the positions and numbers of downlink symbols, uplink symbols, and flexible symbols in the second pattern may be configured with reference to the description of the first pattern based on configuration information of the second pattern. In addition, when the second pattern is configured, the terminal may assume that P+P₂ is a divisor of 20 msec.

The base station may override direction(s) of ‘flexible symbol(s)’ among symbols configured through the higher layer parameter tdd-UL-DL-ConfigurationCommon by using the higher layer parameter tdd-UL-DL-ConfigurationDedicated) based on the following information.
Slot configuration set (i.e., slotSpecificConfigurationsToAddModList): A set of slot configurations
Slot index (i.e., slotIndex): An index of a slot included in the set of slot configurations
Symbol directions (i.e., symbols): The directions of the symbols indicated by the slot index (i.e., slotIndex). If all symbol directions are downlink (symbols=allDownlink), all symbols within the corresponding slot are downlink symbols. If all symbol directions are uplink (symbols=allUplink), all symbols within the corresponding slot are uplink symbols. If the symbol directions are explicit (symbols=explicit), nrofDownlinkSymbols may indicate the number of downlink symbols located in the first part of the corresponding slot, and nrofUplinkSymbols may indicate the number of uplink symbols located in the last part of the corresponding slot. If the nrofDownlinkSymbols or the nrofUplinkSymbols is omitted, the corresponding parameter may be regarded as indicating a value of 0. The remaining symbols within the slot become flexible symbols.

In the 5G communication system, the base station may indicate a slot format to the terminal based on L1 signaling. For example, when the terminal receives a higher layer parameter SlotFormatIndicator from the base station, the terminal may obtain configuration information a slot format indication-RNTI (i.e., SFI-RNTI). Meanwhile, when the terminal receives a higher layer parameter dci-PayloadSize from the base station, the terminal may obtain configuration information of a payload size of the DCI format 2_0. In addition, the terminal may additionally receive, from the base station, information on PDCCH candidate(s), CCE aggregation level, and search space set(s) of a CORESET for monitoring the DCI format 2_0. Each slot format indication (SFI) index field in the DCI format 2_0 may indicate a slot format to be applied to each slot in a slot set of a DL BWP and a UL BWP from a slot in which the terminal has detected the corresponding DCI format 2_0. In this case, the size of the slot set may be equal to or greater than a PDCCH monitoring periodicity of the DCI format 2_0. For example, when the slot set is composed of N slots, the DCI format 2_0 may include N SFI index fields, and each SFI index field may indicate a format value of Table 14 and Table 15 below. In Tables 14 and 15, ‘D’ may mean a downlink symbol, ‘U’ may mean an uplink symbol, and ‘F’ may mean a flexible symbol.

TABLE 14

| Slot | | | | | | | | | | | | | | |
|---|---|---|---|---|---|---|---|---|---|---|---|---|---|---|
| for- | Symbol number within a slot | | | | | | | | | | | | | |
| mat | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |

TABLE 15

| | | | | | | | | | | | | | | |
|---|---|---|---|---|---|---|---|---|---|---|---|---|---|---|
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56- | Reserved |
| 254 | |
| 255 | UE determines a slot format of a slot based on a higher layer |
| | parameter tdd-UL-DL-ConfigurationCommon or a higher layer |
| | parameter tdd-UL-DL-ConfigurationDedicated, and a detected |
| | DCI format (when exists). |

In the 5G NR communication system, it may be possible to support flexible and dense wireless backhaul links for each cell through the JAB feature, without support of a wired network.

FIG. 13 is a sequence chart illustrating an exemplary embodiment of a UL capability reporting procedure in a communication system.

Referring to FIG. 13, in the UE capability reporting procedure, the base station may transmit a UE capability report request signal to the terminal through a higher layer parameter UECapabilityEnquiry when the terminal is in RRC connected mode (i.e., RRC_CONNECTED state) (S1300). In this case, the network may refer to only the UE capability report after access stratum (AS) security activation, and may not retransmit or report the UE capability report before the AS security activation to the core network (CN). Upon receiving the UE capability report request signal, the terminal may compile UE capability information according to a specific procedure, and report it to the base station through a UE capability information signal (e.g., UECapabilityInformation) (S1310).

The specific procedure for compiling the UE capability information signal may include a procedure of generating at least one of a list (i.e., supportedBandCombinationList) of band(s) or band combination(s) (BC(s)) supported by the terminal, feature set (FS) information related to feature sets supported by the terminal, or feature set combination (FSC) information related to feature set combinations supported by the terminal. For example, when the base station requests a UE capability report from the terminal in order to obtain information on band(s) or band combination(s) supported by the terminal, the terminal may report which band(s) it supports for each radio access technology (RAT). To this end, the base station may set a RAT-type in a UE RAT capability report request signal (e.g., UE-CapabilityRAT-Request), which is included in a UE RAT capability report request list signal (e.g., ue-CapabilityRAT-RequestList) that is a higher layer message, to one of ‘nr’, ‘eutra-nr’, ‘eutra’, and ‘eutra-fdd’. This may mean that the base station may request a UE capability report for one or more RATs or RAT combinations from the terminal, and in this case, the terminal may respond to each request for a list of support bands for a plurality of RATs or RAT combinations. For example, if the RAT-type is set to ‘nr’, the terminal may include a list of bands or band combinations to which NR-DC can be applied in the UE capability report. As another example, if the RAT-type is set to ‘eutra-nr’, the terminal may include a list of bands or band combinations applicable to multi-RAT DC (MR-DC) such as EN-DC, NGEN-DC, NE-DC, or the like in the UE capability report. In addition, when the base station requests a UE capability report, the base station may provide, to the terminal, a list of bands for which the terminal determines whether support is provided, through a higher layer parameterfrequencyBandListFilter. For the bands included in the higher layer parameter frequencyBandListFilter, the terminal may determine a candidate band combination by considering ‘predetermined RAT types supported for each band’, ‘information on RAT-types requested by the base station’, etc., and may include the candidate band combination in the UE capability report.

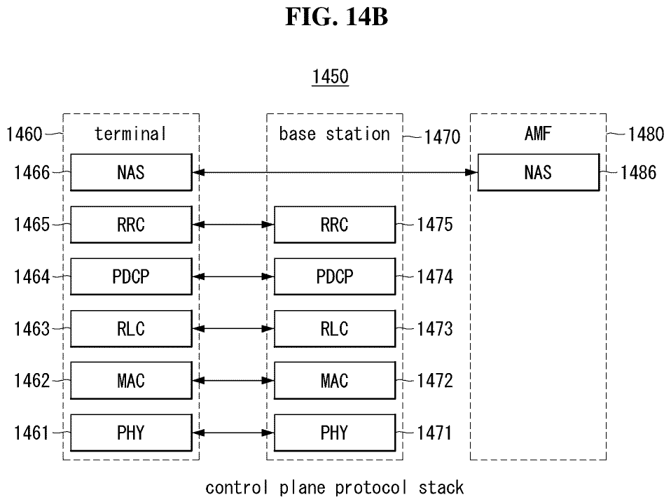

FIG. 14A is a conceptual diagram for describing a first exemplary embodiment of a user plane protocol stack structure in a communication system. FIG. 14B is a conceptual diagram for describing a first exemplary embodiment of a control plane protocol stack structure in a communication system.

Referring to FIGS. 14A and 14B, a radio interface protocol stack or radio interface protocol stack structures 1400 and 1450 may be defined in a radio connection section between communication nodes. For example, the radio interface protocol stack may be divided into a physical layer, a data link layer, a network layer, and the like, which are vertically configured.

The radio interface protocol stack may be divided into the user plane protocol stack 1400 and the control plane protocol stack 1450. Here, the control plane may be a plane for transmitting a control signal. The control signal may be referred to as a signaling signal. The user plane may be a plane for transmitting user data.

Referring to FIG. 14A, the communication system may include a terminal 1410 and abase station 1420. The terminal 1410 may be referred to as a user equipment (UE). The base station 1420 may correspond to an eNB, a gNB, or the like. The terminal 1410 and the base station 1420 may perform mutual data signal transmission/reception based on the user plane protocol stack structure 1400 shown in FIG. 14A.

In the user plane air interface protocol stack structure 1400 of the communication system, the terminal 1410 and the base station 1420 may include PHY layers 1411 and 1421 included in L1, MAC layers 1412 and 1422, RLC layers 1413 and 1423, and packet data convergence protocol (PDCP) layers 1414 and 1424 included in L2, service data adaptation protocol (SDAP) layers 1415 and 1425 included in L3, and the like.

Referring to FIG. 14B, the communication system may include a terminal 1460 and a base station 1470. The terminal 1460 and the base station 1470 may perform mutual control signal transmission/reception based on the control plane protocol stack structure 1450 shown in FIG. 14B.

In the control plane protocol stack structure 1450 of the communication system, the terminal 1460 and the base station 1470 may include PHY layers 1461 and 1471 included in L1, MAC layers 1462 and 1472, RLC layers 1463 and 1473, and PDCP layers 1464 and 1474 included in L2, and RRC layers 1465 and 1475 included in L3, and the like.

The communication system may further include an Access and Management Mobility Function (AMF) 1480. In the control plane protocol stack structure 1450, the terminal 1460 and the AMF 1480 may include non-access stratum (NAS) layers 1466 and 1486. The base station 1470 may not include a NAS layer. In other words, in the control plane protocol stack structure 1450, the NAS layer of the base station 1470 may be transparent.

In the 5G NR communication system, it may be possible to support flexible and dense wireless backhaul links for each cell through the IAB feature, without support of a wired network.

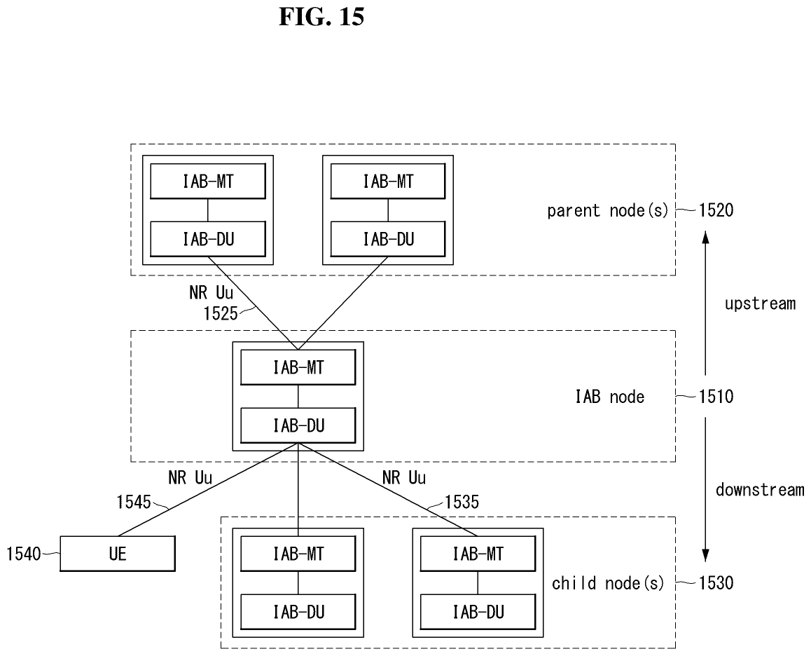

FIG. 15 is a conceptual diagram illustrating an exemplary embodiment of an IAB network in a communication system.

Referring to FIG. 15, a communication system 1500 may include one or more communication nodes. The communication nodes of the communication system 1500 may constitute an IAB network. For example, the communication system 1500 may include one or more IAB nodes. FIG. 15 shows an exemplary embodiment in which one IAB node communicates with one or more upper nodes and one or more lower nodes. However, this is merely an example for convenience of description, and exemplary embodiments of the present disclosure are not limited thereto.

The communication system 1500 may include a plurality of IAB nodes. For example, the communication system 1500 may include a first IAB node 1510, one or more parent nodes 1520 corresponding to upper nodes of the first IAB node 1510, and/or one or more child nodes 1530 corresponding to lower nodes of the first IAB node 1510. Here, each of the one or more parent nodes 1520 may be referred to as a ‘donor node’. The IAB node 1510, the one or more parent nodes 1520, and/or the one or more child nodes 1530 may constitute the IAB network. Each of the IAB nodes 1510, 1520, and 1530 constituting the IAB network may function as a type of repeater configured based on a front-haul structure. In the communication system 1500 to which the IAB network technology is applied, it is possible to support flexible and dense wireless backhaul links for each cell without support of a wired network.

Each of the IAB nodes 1510, 1520, and 1530 may include an IAB-DU and an IAB-MT. The IAB-MT may allow each IAB node to function as a terminal in communication with an upper node. For example, the first IAB node 1510 may communicate with the upper parent nodes 1520 through the IAB-MT. On the other hand, the IAB-DU may allow each IAB node to function as a base station or a cell in communication with a lower node. For example, the first IAB node 1510 may communicate with the lower child nodes 1530 or a terminal 1540 through the IAB-DU.

The IAB-MT of the first IAB node 1510 may be connected to the IAB-DUs of the parent nodes 1520 through Uu interfaces 1525. The IAB-DU of the first IAB node 1510 may be connected to the IAB-MTs of the child nodes 1530 through Uu interfaces 1535. The IAB-DU of the first IAB node 1510 may be connected to a terminal 1540 through a Uu interface 1545.

After the IAB node constituting the IAB network completely decodes a received signal, the IAB node may re-encode the decoded received signal, and amplify and transmit it. The IAB node may be classified as a type of regenerative relay. To this end, the IAB node may support a control plane (CP) and a user plane (UP) from the parent node to the terminal based on a protocol stack structure including the L1 and L2 layers, or higher layers.

The IAB node constituting the IAB network has an advantage of being able to perform various operations including operations as a base station and a terminal. On the other hand, the IAB node has disadvantages in that implementation complexity and production cost are relatively high, and a delay required for retransmission may be relatively large.

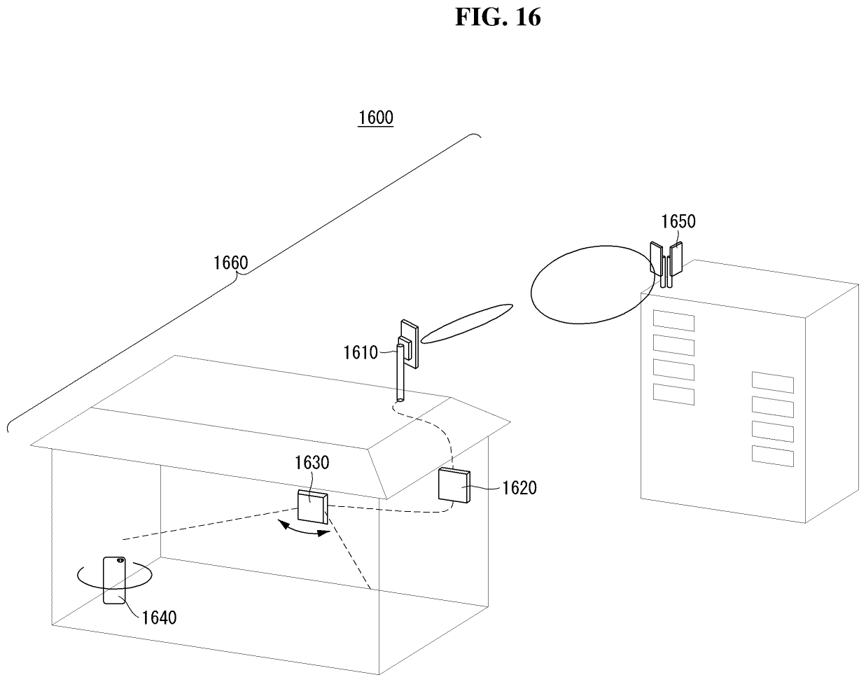

FIG. 16 is a conceptual diagram illustrating a first exemplary embodiment of a signal transmission/reception method based on a wireless repeater in a communication system.

Referring to FIG. 16, a communication system 1600 may include one or more communication nodes. For example, the communication system 1600 may include one or more base stations and one or more terminals. The communication system 1600 may include one or more repeaters that relay communications between one or more communication nodes. FIG. 16 shows an exemplary embodiment in which one repeater relays communications between one base station existing outdoors and one terminal existing indoors. However, this is merely an example for convenience of description, and exemplary embodiments of the present disclosure are not limited thereto. For example, an exemplary embodiment of the communication system 1600 may include a plurality of base stations, terminals, and/or repeaters to perform mutual communications.

In an exemplary embodiment of the communication system 1600, a repeater 1620 including an outdoor antenna 1610 may receive and relay a radio signal received in an outdoor space. The repeater 1620 may be classified as a type of non-regenerative repeater that amplifies and retransmits received signals. When the repeater 1620 further includes an indoor antenna 1630, the repeater 1620 may relay a radio signal received from the outdoor space to an indoor space. Alternatively, the repeater 1620 may relay a radio signal received in the indoor space to the outdoor space. The repeater 1620 may be a radio frequency (RF) repeater mainly used to cover an indoor radio shadow area. The respective elements constituting the repeater 1620 may be interconnected by wire or wirelessly.

The repeater 1620 may relay communications between a terminal 1640 located indoors and a base station 1650 located outdoors through the indoor and outdoor antennas 1610 and 1630. For example, the repeater 1620 may receive a downlink signal transmitted from the base station 1650 through the outdoor antenna 1610. The repeater 1620 may amplify the received signal and transmit it to the terminal 1640 in the indoor space through the indoor antenna 1630. On the other hand, the repeater 1620 may receive an uplink signal transmitted from the terminal 1640 through the indoor antenna 1630. The repeater 1620 may amplify the received signal and transmit it to the base station 1650 through the outdoor antenna 1610. The outdoor antenna 1610 may be referred to as a ‘first antenna’, and the indoor antenna 1620 may be referred to as a ‘second antenna’. Hereinafter, configurations related to an operation in which the repeater 1620 relays a downlink signal will be described as an example. However, this is merely an example for convenience of description, and exemplary embodiments of the present disclosure are not limited thereto. For example, exemplary embodiments of the present disclosure may be equally or similarly applied to an operation of the repeater 1620 relays an uplink signal.

Commercial RF repeaters are generally capable of operating in the FR1 band. In the FR1 band, the base station 1650 may perform communications through one beam per one cell or one sector. Here, the base station 1650 may correspond to an eNodeB (eNB) or a gNodeB (gNB). The outdoor antenna 1610 provided for communications with the base station 1650 may be a directional antenna. For example, the outdoor antenna 1610 may be a directional log-periodic dipole array (LPDA) type antenna. The outdoor antenna 1610 may be installed to face the direction of the base station. The indoor antenna 1630 provided for communications with the terminal 1640 may be a patch antenna. For example, the indoor antenna 1630 may be configured as a patch antenna having an effective coverage of about 70 degrees to 75 degrees. The indoor antenna 1630 may support communications with the terminal 1640 operating in an omni-directional beam scheme or an omni-beam scheme.

The base station 1650 may recognize all beams on a communication path from the base station 1650 to the terminal 1640 through the repeater 1620 as one ‘single virtual TX beam’. On the other hand, the base station 1650 may recognize all beams on a communication path from the terminal 1640 to the base station 1650 through the repeater 1620 as one ‘single virtual RX Beam’.

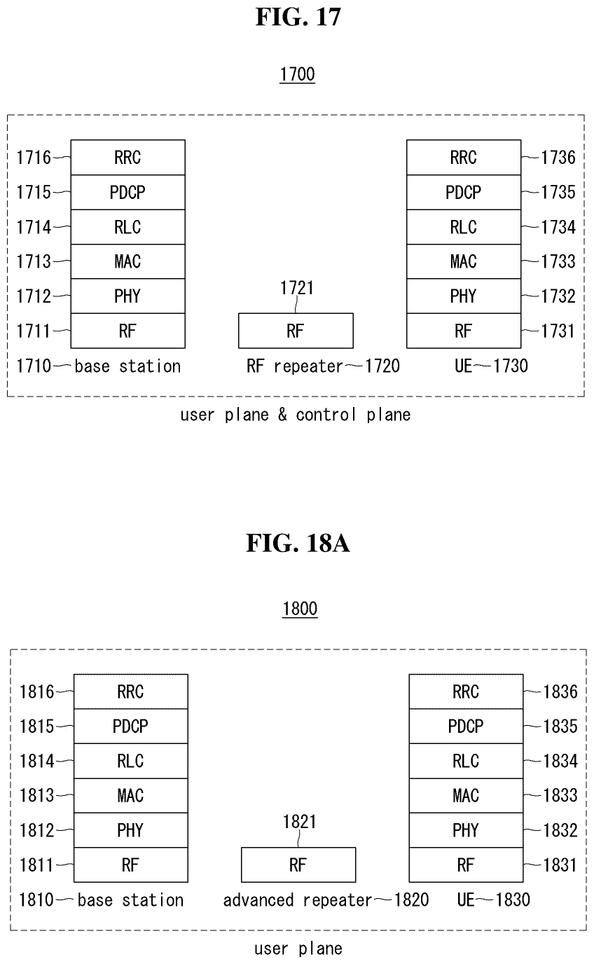

FIG. 17 is a conceptual diagram illustrating a first exemplary embodiment of a user plane and a control plane in a communication system including a wireless repeater.

Referring to FIG. 17, in a radio connection section between communication nodes, a radio interface protocol or a radio interface protocol stack structure 1700 may be defined. For example, the radio interface protocol may be divided into a physical layer, a data link layer, a network layer, and the like which are vertically configured.

The radio interface protocol may be divided into a user plane and a control plane. Here, the control plane may be a plane for control signal transmission. The control signal may be referred to as a signaling signal. The user plane may be a plane for user data transmission.

In an exemplary embodiment of the communication system, the communication system may include a base station 1710 and a terminal 1730. For example, the base station 1710 may correspond to an eNB, a gNB, or the like. The terminal 1730 may be referred to as a ‘user equipment (UE)’. The communication system may include a repeater 1720 that relays wireless communications between the base station 1710 and the terminal 1730. The repeater 1720 may correspond to an RF repeater. The base station 1710, the repeater 1720, and the terminal 1730 of the communication system may be the same as or similar to the base station 1650, the repeater 1620, and the terminal 1640 described with reference to FIG. 16, respectively.

In the user plane of the radio interface protocol stack structure 1700 of the communication system, the base station 1710 and the terminal 1730 may include PHY layers 1712 and 1732 included in a layer 1 (L1), MAC layers 1713 and 1733 included in a layer 2 (L2), radio link control (RLC) layers 1717 and 1734, packet data convergence protocol (PDCP) layers 1715 and 1735, and the like, respectively. On the other hand, in the control plane of the protocol stack structure 1700, the base station 1710 and the terminal 1730 may include PHY layers 1712 and 1732 included in a L1, MAC layers 1713 and 1733 included in a L2, RLC layers 1717 and 1734, PDCP layers 1715 and 1735, RRC layers 1716 and 1736 included in a layer 3 (L3), and the like, respectively. The base station 1710 and the terminal 1730 may perform radio signal transmission/reception through RF functions 1711 and 1731.

Meanwhile, in the user plane and the control plane of the protocol stack structure 1700, the RF repeater 1720 may not include the layers such as the PHY layer to the RRC layer, may receive and amplify signals transmitted from the base station 1710 and the terminal 1730 based on the RF function 1721, and may transmit or retransmit the amplified signals. In other words, in the user plane and the control plane of the protocol stack structure 1700, the layers such as the PHY layer to the RRC layer of the repeater 1720 may be transparent, and the radio signal received at the repeater may be amplified, transmitted, and/or retransmitted in terms of the RF function 1721.

In exemplary embodiments of a repeater, such as the repeater 1620 described with reference to FIG. 16 and the repeater 1720 described with reference to FIG. 17, the repeater may repeatedly perform reception, amplification, transmission and/or retransmission operations for the RF signal simply based on the RF function, an RF signal. In this case, the complexity and cost of implementing the repeater and the communication system including the repeater may be low.

Meanwhile, in exemplary embodiments of a repeater such as the repeater 1620 described with reference to FIG. 16 and the repeater 1720 described with reference to FIG. 17, the base station and the communication network may not be able to secure control over the repeater. In this case, the performance of the repeater may be limited in the FR2 band requiring multi-beam operations. For example, in order to improve signal quality in the FR2 band and to control the amount of interference on a communication path, explicit or implicit management and indication operations for the repeater beams may be required. However, for a repeater including only a simple RF function, explicit or implicit management and indication operations for the repeater beams may not be performed. A technique for improving the performance of the repeater in the FR2 band requiring multi-beam operations may be required.

In exemplary embodiments of a repeater, such as the repeater 1620 described with reference to FIG. 16 and the repeater 1720 described with reference to FIG. 17, the performance of the repeater may be limited in a time division duplexing (TDD) frequency band (e.g., 3.5 GHz band or FR2) that requires sophisticated DL/UL switching or an FR2 band that requires multi-beam operations. In the 5G system, a transmission direction for slot(s) or symbol(s) may be dynamically indicated according to slot format configuration or indication transmitted through L1 signaling. Alternatively, a beam, TCI, or QCL for each channel may be indicated dynamically. However, since the RF repeater does not decode a transmission signal of the base station, it may be difficult to recognize the aforementioned indication. A technique for the repeater to decode a part or all of transmission signals of the base station may be required.

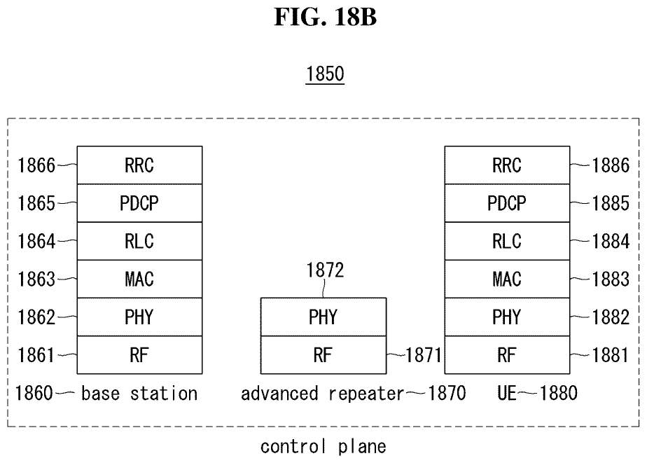

FIG. 18A is a conceptual diagrams illustrating a second exemplary embodiment of a user plane in a communication system including a wireless repeater. FIG. 18B is a conceptual diagrams illustrating a second exemplary embodiment of a control plane in a communication system including a wireless repeater.

Referring to FIGS. 18A and 18B, in a radio connection section between communication nodes, a radio interface protocol or a radio interface protocol stack structure 1800 or 1850 may be defined. The radio interface protocol may be divided into a user plane and a control plane. Hereinafter, in describing the second exemplary embodiment of the user plane and the control plane in the communication system with reference to FIGS. 18A and 18B, the content overlapping with those described with reference to FIGS. 1 to 17 may be omitted.

In an exemplary embodiment of the communication system, the communication system may include base stations 1810 and 1860 and terminals 1830 and 1880. The communication system may include repeaters 1820 and 1870 that relay wireless communications between the base stations 1810 and 1860 and the terminals 1830 and 1880. Here, the repeaters 1820 and 1870 may be repeaters with advanced or enhanced functions compared to the repeater 1620 described with reference to FIG. 16. Alternatively, the repeaters 1820 and 1870 may be lower-cost repeaters than the IAB nodes 1610, 1620, and 1630 described with reference to FIG. 15. The repeaters 1820 and 1870 described with reference to FIG. 18 may be referred to as ‘advanced repeaters’.

Referring to FIG. 18A, in the user plane 1800 of the radio interface protocol stack structure of the communication system, the base station 1810 and the terminal 1830 may include PHY layers 1812 and 1432, MAC layers 1813 and 1833, RLC layers 1814 and 1434, PDCP layers 1815 and 1835, and the like, respectively. In an exemplary embodiment of the communication system, in the user plane 1800 of the radio interface protocol stack structure of the communication system, the base station 1810 and the terminal 1830 may further include RRC layers (not shown). The base station 1810 and the terminal 1830 may perform radio signal transmission/reception through RF functions 1811 and 1831, respectively. In the user plane 1800 of the protocol stack structure, the repeater 1820 may not include the layers such as the PHY layer to the PDCP layer, and may receive and amplify signals transmitted from the base station 1810 and the terminal 1830 based on the RF function 1821, and may transmit or retransmit the amplified signals. In the user plane 1800 of the protocol stack structure, the layers such as the PHY layer to the RRC layer of the repeater 1820 may be transparent, and the radio signals received by the repeater 1820 may be amplified, transmitted, and/or retransmitted in terms of the RF function 1821.

On the other hand, referring to FIG. 18B, in the control plane 1850 of the protocol stack structure, the base station 1860 and the terminal 1880 may include PHY layers 1862 and 1882, MAC layers 1863 and 1883, RLC layers 1864 and 1884, PDCP layers 1865 and 1885, RRC layers 1866 and 1886, and the like, respectively. The base station 1860 and the terminal 1880 may perform radio signal transmission/reception through RF functions 1861 and 1881, respectively. In the control plane 1850 of the protocol stack structure, the repeater 1870 may further include a PHY layer 1872 in addition to an RF function 1871. The PHY layer 1872 of the repeater 1870 corresponding to an advanced repeater may be used for management operations of the base station 1860 for the repeater 1870. For example, the PHY layer 1872 of the repeater 1870 may process information for reporting capability of the repeater 1870. The PHY layer 1872 of the repeater 1870 may process information for management and indication of the base station 1860 for beams of the repeater 1860. The PHY layer 1872 of the repeater 1870 may process information for management and indication of the of the base station 1860 for slot formats of the repeater 1870. When the repeater 1870 performs an operation based on the PHY layer 1872 rather than simply performing an operation based on the RF function 1871 in the control plane 1850 of the protocol stack structure, the base station 1860 may control a beam or a combination of beams on a link between the base station 1860 and the repeater 1870 and/or a link between the repeater 1870 and the terminal 1880. In addition, the base station 1860 may control slot formats on the link between the base station 1860 and the repeater 1870 and/or the link between the repeater 1870 and the terminal 1880. However, this is merely an example for convenience of description, and the embodiments of the present disclosure are not limited thereto. For example, when the repeater 1870 operates depending on L2 and/or L3 signaling, the repeater 1870 may further include an upper layer (e.g., MAC layer).

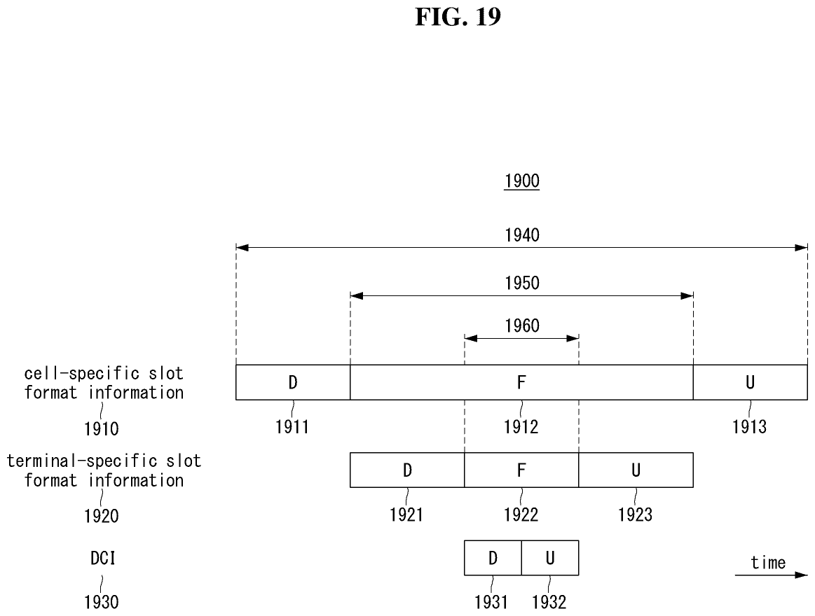

FIG. 19 is a conceptual diagram illustrating exemplary embodiments of a DL/UL pattern region.

Referring to FIG. 19, within a specific time period, slot formats may be configured as ‘downlink (D)’ 1911, ‘flexible (F)’ 1912 and/or ‘uplink (U)’ 1913 according cell-specific slot format information 1910 (e.g., configuration through a higher layer parameter tdd-UL-DL-ConfigurationCommon). The F 1912 may be configured as D 1921, F 1922, and/or U 1923 in detail according to terminal-specific slot format information 1920 (e.g., configuration through a higher layer parameter tdd-UL-DL-ConfigurationDedicated). A region 1960 configured as F 1922 by the terminal-specific slot format information 1920 in a region configured as F 1912 by the cell-specific slot information 1910 may be indicated as D 1931 and/or U 1932 by DCI 1930 (e.g., SFI included in a DCI format 2_0). In FIG. 19, the order of slots D 1911, 1921, and 1931 and U 1913, 1923, and 1933 is a simple example, and may be changed to suit an actual channel environment or operator's preference.

The exemplary embodiments of FIG. 19 are described as being applicable to time-domain resources such as frames, slots, or symbols, but this is for ease of understanding. In actual applications, they may be applied to frequency-domain resources such as bands, component carriers (CC), cell, or bandwidth part (BWP).

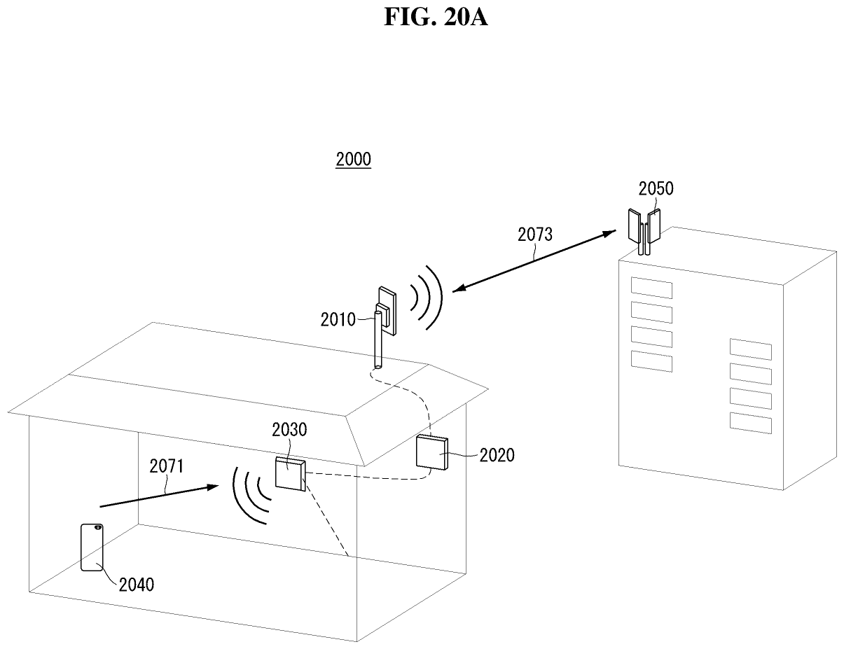

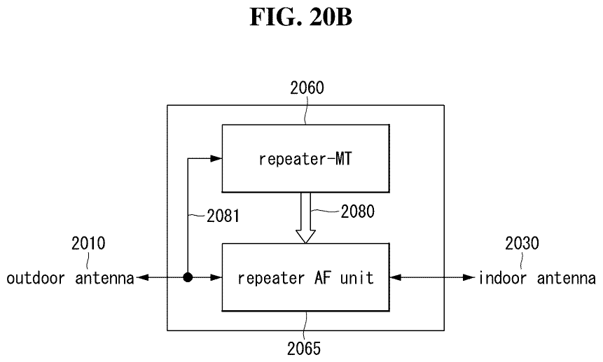

FIGS. 20A and 20B are conceptual diagrams for describing a first exemplary embodiment of a wireless repeater in a communication system.

Referring to FIGS. 20A and 20B, a communication system 2000 may include one or more communication nodes. For example, the communication system 2000 may include one or more base stations and one or more terminals. The communication system 2000 may include one or more repeaters that relay communication between one or more communication nodes. FIGS. 20A and 20B illustrate an exemplary embodiment in which one repeater relays communication between one base station located outdoors and one terminal located indoors. However, this is merely an example for convenience of description, and exemplary embodiments of the present disclosure are not limited thereto. For example, an exemplary embodiment of the communication system 2000 may include a plurality of base stations, terminals, and/or repeaters that communicate with each other. Hereinafter, in describing the first exemplary embodiment of the wireless repeater in the communication system with reference to FIGS. 20A and 20B, description redundant with those described with reference to FIGS. 1 to 19 may be omitted.

Referring to FIG. 20A, in an exemplary embodiment of the communication system 2000, a repeater 2020 including an outdoor antenna 2010 and an indoor antenna 2030 may relay a wireless signal received from an outdoor space to an indoor space. Alternatively, the repeater 2020 may relay a wireless signal received from an indoor space to an outdoor space. The outdoor antenna 2010 may be referred to as ‘mobile terminal (MT) antenna’, ‘input antenna’, ‘first antenna’, or ‘first antenna group’. The indoor antenna 2030 may be referred to as ‘radio unit or remote unit (RU) antenna’, ‘output antenna’, ‘second antenna’, or ‘second antenna group’.

The repeater 2020 may relay communication between a terminal 2040 located indoors and a base station 2050 located outdoors. Hereinafter, configurations related to an operation for the repeater 2020 to relay a downlink signal transmitted from the base station 2050 will be described as an example. However, this is merely an example for convenience of description, and exemplary embodiments of the present disclosure are not limited thereto. For example, exemplary embodiments of the present disclosure may be equally or similarly applied to an operation of the repeater 2020 for relaying an uplink signal transmitted from the terminal 2040.

In another exemplary embodiment, when the repeater 2020 relays a signal from the base station 2050 to a terminal located outdoors, the outdoor antenna 2010 and the indoor antenna 2030 may be replaced with co-located antennas that share at least one of statistical channel characteristics. Alternatively, when the repeater 2020 relays a signal from the base station 2050 to a terminal located outdoors, the outdoor antenna 2010 and the indoor antenna 2030 may be replaced with different logical antennas using the same physical antenna.

The repeater 2020 may be a network-controlled (NWC) repeater. The repeater 2020 may amplify and/or retransmit received wireless signals. For example, the repeater 2020 may amplify wireless signals received from the base station 2050 and/or the terminal 2040 and transmit them to another communication node (e.g., the terminal 2040 and/or the base station 2050). The repeater 2020 may include one or more antennas or antenna groups 2010 and 2030 capable of receiving and/or transmitting wireless signals.

In an exemplary embodiment of the communication system 2000, a first antenna 2010 (or first antenna group) connected to a signal processing unit of the repeater 2020 may be used for wires connection between the repeater 2020 and the base station 2050 in an outdoor environment. A second antenna 2030 (or second antenna group) connected to the signal processing unit of the repeater 2020 may be used for wireless connection between the repeater 2020 and the terminal 2040 in an indoor environment. In this case, a base station-repeater link 2073 may be configured with a control link through which signals for the base station 2050 to control the repeater 2020 are transmitted, and a backhaul link through which signals for the base station 2050 to service the terminal 2040 are transmitted. The wireless link between the repeater and the terminal may be collectively referred to as an access link.

Referring to FIG. 20B, the signal processing unit of the repeater 2020 may include a repeater-MT 2060 that receives and processes a control signal of the base station 2050, a repeater amplify-and-retransmit (AF) unit 2065 that amplifies and retransmits a signal of the base station 2050, and the like. The repeater AF unit 2065 may also be referred to as a repeater-forward (Fwd) unit. In an exemplary embodiment of the communication system 2000, the repeater 2020 may be implemented identically or similarly to the configuration of the repeater 2020 shown in FIG. 20B. The repeater 2020 may further include additional components and/or functions in addition to the configuration of the repeater 2020 shown in FIG. 20B.

The repeater MT 2060 and the repeater AF unit 2065 of the repeater 2020 may be connected to a wireless link with the base station 2050 through the first antenna 2010 (or first antenna group). The repeater-MT 2060 may receive repeater control information 2081 from the first antenna 2010 (or first antenna group). The repeater-MT 2060 may indicate the repeater AF unit 2065 to perform a repeater control procedure (or operation procedure) corresponding to the received repeater control information 2081 through an internal control interface 2080. The repeater AF unit 2065 may amplify a signal of the base station 2050 received at the first antenna 2010 (or first antenna group) according to the indicated repeater control procedure (or operation procedure), and may retransmit the amplified signal of the base station 2050 to the terminal 2040 through the second antenna 2030 (or second antenna group). On the other hand, the repeater AF unit 2065 may amplify a signal 2071 of the terminal 2040 received at the second antenna 2030 (or second antenna group) according to the indicated repeater control procedure (or operation procedure), and may retransmit the amplified signal of the terminal 2040 to the base station 2050 through the first antenna 2010 (or first antenna group).

The repeaters described with reference to at least one of FIGS. 16 to 20B may be classified as follows.
First type repeater: The first type repeater may not include a signal processing unit for decoding or re-encoding a signal received from the base station or terminal. The first type repeater may determine a transmission direction (e.g., slot format) or beam direction (e.g., TCI or QCL) based on characteristics (e.g., received signal strength, signal quality, signal-to-noise ratio, reception time period, or variation (e.g., envelope detection) of a received signal strength) of a wireless signal received from the base station or terminal. Therefore, the first type repeater may perform monitoring to determine the characteristics of the wireless signal received from the base station or terminal in a specific time/frequency resource.
Second type repeater: The second type repeater may include a signal processing unit for receiving cell-specific system information broadcast by the base station. In an exemplary embodiment, the cell-specific system information broadcast by the base station may refer to DL/UL pattern information preconfigured when installing the repeater or DL/UL pattern information configured through an application layer. In another exemplary embodiment, the cell-specific system information broadcast by the base station may include slot format information (i.e., information indicating D, F, and/or U) configured by a higher layer parameter (e.g., tdd-UL-DL-ConfigurationCommon). In this case, the second type repeater may use information corresponding to tdd-UL-DL-ConfigurationCommon among configuration information for slot format indication, and may assume that terminal-specific configuration information (e.g., tdd-UL-DL-ConfigurationDedicated) is not available. The second type repeater may determine only static or semi-static transmission directions. That is, a transmission direction of a time period configured with flexible (F) symbols by tdd-UL-DL-ConfigurationCommon (e.g., resources terminal-specifically configured by tdd-UL-DL-ConfigurationDedicated or resources whose transmission direction is dynamically indicatable by L1 signaling (e.g., DCI format 2_0)) may not be determined by higher layer signaling (e.g., RRC signaling). The second type repeater may perform wireless signal monitoring on the time period configured with F symbols by tdd-UL-DL-ConfigurationCommon (e.g., resources terminal-specifically configured by tdd-UL-DL-ConfigurationDedicated or resources whose transmission direction is dynamically indicatable by L1 signaling (e.g., DCI format 2_0)).
Third type repeater: The third type repeater may include a signal processing unit capable of receiving all control information transmitted by the base station. The third type repeater may recognize and/or perform all slot format indication procedures or applications related to slot format indication by using not only cell-specific configuration information (e.g., tdd-UL-DL-ConfigurationCommon) but also terminal-specific configuration information (e.g., tdd-UL-DL-ConfigurationDedicated) or L1 signaling (e.g., DCI format 2_0, other DCI formats including SFI, etc.).

The above-described first to third types of repeaters are merely examples for ease of understanding, and the types of repeaters are not limited thereto. The first to third types of repeaters may be extended or modified appropriately in actual application. As an example, the type 2 repeater may be classified into more sub-types.

The repeater may have various internal structures depending on the number and configuration of amplification unit(s) comprising power amplifier(s) (PA(s)), radio frequency (RF) amplifier(s), one or more amplifier groups, and/or the like.

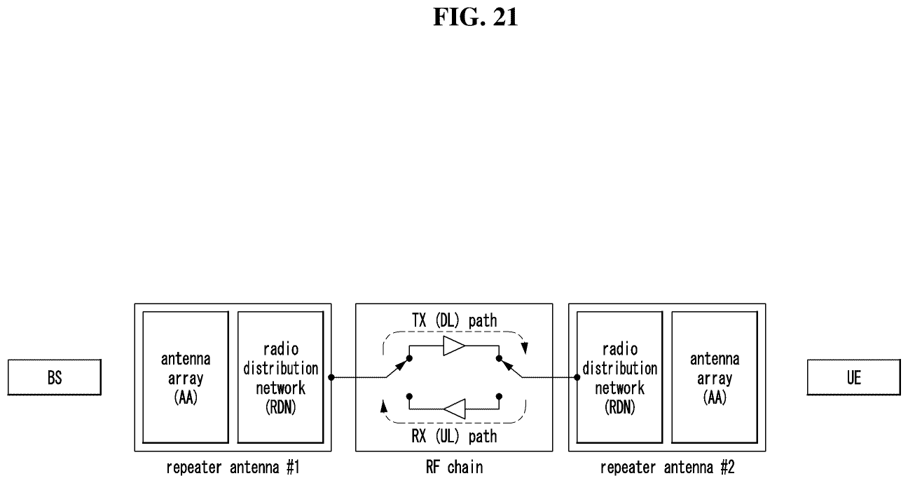

FIG. 21 is a conceptual diagram for describing a first exemplary embodiment of a wireless repeater configuration in a communication system.

Referring to FIG. 21, the communication system may include a repeater. Here, the repeater may mean a repeater controlled by a network. The communication system may include a NWC repeater. The NWC repeater may also be referred to as ‘NCR’. Hereinafter, in describing the first exemplary embodiment of the wireless repeater configuration in the communication system with reference to FIG. 21, description redundant with those described with reference to FIGS. 1 to 20B may be omitted.

In the first exemplary embodiment of the wireless repeater configuration in the communication system, the repeater may include a repeater antenna #1 and a repeater antenna #2. The repeater antenna #1 may be used for signal transmission and reception on a base station-repeater link. The repeater antenna #2 may be used for signal transmission and reception on a terminal-repeater link.

The repeater antenna #1 and/or the repeater antenna #2 may be configured as one antenna. Alternatively, the repeater antenna #1 and/or the repeater antenna #2 may be configured as an antenna group or a composite antenna in which a plurality of antennas are combined. The repeater antenna #1 and the repeater antenna #2 may be respectively configured with an antenna array (AA) and a radio distribution network (RDN) that distributes signals from antenna elements within the AA to RF chain(s).

In the first exemplary embodiment of the wireless repeater configuration in the communication system, RF chain(s) of the repeater may be configured with a TX (DL) path and an RX (UL) path. The repeater may include a separate amplifier for each of the TX (DL) path and the RX (UL) path. The repeater may connect the repeater antennas with the TX (DL) path or with the RX (UL) path, according to a communication direction such as UL, DL, etc. determined (or indicated, detected, etc.) at each time point.

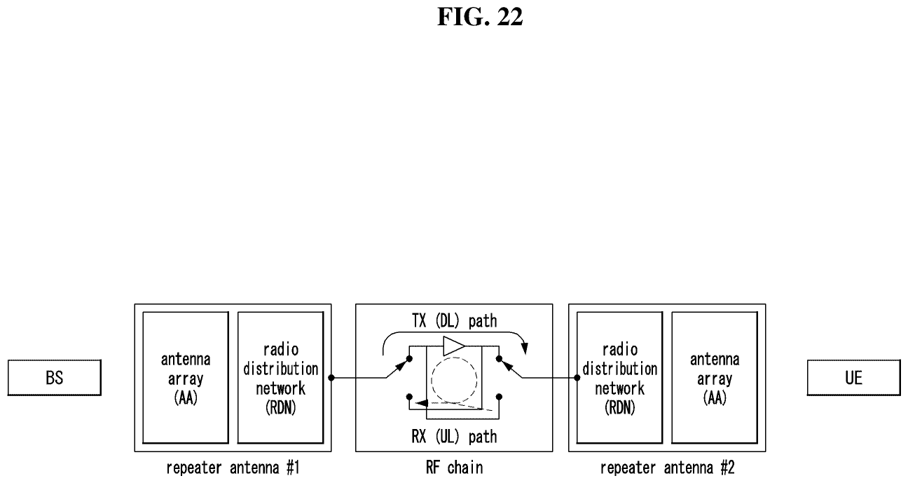

FIG. 22 is a conceptual diagram for describing a second exemplary embodiment of a wireless repeater configuration in a communication system.

Referring to FIG. 22, the communication system may include a repeater. Here, the repeater may mean a repeater controlled by a network. The communication system may include a NWC repeater. The NWC repeater may also be referred to as ‘NCR’. Hereinafter, in describing the second exemplary embodiment of the wireless repeater configuration in the communication system with reference to FIG. 22, description redundant with those described with reference to FIGS. 1 to 21 may be omitted.

In the second exemplary embodiment of the wireless repeater configuration in the communication system, the repeater may include a repeater antenna #1 and a repeater antenna #2. The repeater antenna #1 may be used for signal transmission and reception on a base station-repeater link. The repeater antenna #2 may be used for signal transmission and reception on a terminal-repeater link.

The repeater antenna #1 and/or the repeater antenna #2 may be configured as one antenna. Alternatively, the repeater antenna #1 and/or the repeater antenna #2 may be configured as an antenna group or a composite antenna in which a plurality of antennas are combined. The repeater antenna #1 and the repeater antenna #2 may be respectively configured with an antenna array (AA) and a radio distribution network (RDN) that distributes signals from antenna elements within the AA to RF chain(s).

In the second exemplary embodiment of the wireless repeater configuration in the communication system, RF chain(s) of the repeater may be configured with a TX (DL) path and an RX (UL) path. The repeater may include a common amplifier for the TX (DL) path and the RX (UL) path. The repeater may select a connection scheme of the repeater antennas as corresponding to the TX (DL) path or corresponding to the RX (UL) path, according to a communication direction such as UL, DL, etc. determined (or indicated, detected, etc.) at each time point.

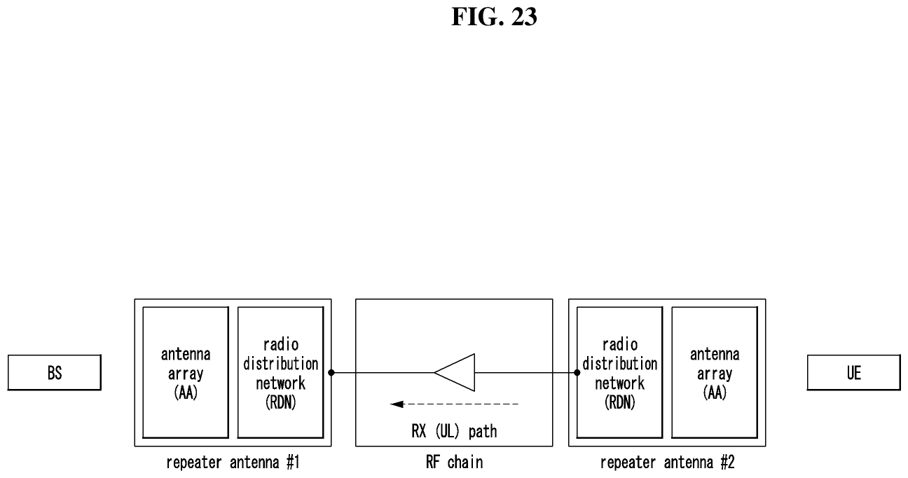

FIG. 23 is a conceptual diagram for describing a third exemplary embodiment of a wireless repeater configuration in a communication system.

Referring to FIG. 23, the communication system may include a repeater. Here, the repeater may mean a repeater controlled by a network. The communication system may include a NWC repeater. The NWC repeater may also be referred to as ‘NCR’. Hereinafter, in describing the third exemplary embodiment of the wireless repeater configuration in the communication system with reference to FIG. 23, description redundant with those described with reference to FIGS. 1 to 22 may be omitted.

In the third exemplary embodiment of the wireless repeater configuration in the communication system, the repeater may include a repeater antenna #1 and a repeater antenna #2. The repeater antenna #1 may be used for signal transmission and reception on a base station-repeater link. The repeater antenna #2 may be used for signal transmission and reception on a terminal-repeater link.

The repeater antenna #1 and/or the repeater antenna #2 may be configured as one antenna. Alternatively, the repeater antenna #1 and/or the repeater antenna #2 may be configured as an antenna group or a composite antenna in which a plurality of antennas are combined. The repeater antenna #1 and the repeater antenna #2 may be respectively configured with an antenna array (AA) and a radio distribution network (RDN) that distributes signals from antenna elements within the AA to RF chain(s).

In the third exemplary embodiment of the wireless repeater configuration in the communication system, RF chain(s) of the repeater may consist of only a RX (UL) path without a TX (DL) path. For example, considering that a bottleneck of a wireless link occurs at an uplink coverage limitation due to a limited transmission power of a terminal, in order to reduce the cost of implementing and installing the repeater and suppress the occurrence of downlink interference caused by the repeater, the repeater may be configured with only the RX (UL) path. In this case, the repeater may include an amplifier corresponding to the RX (UL) path. In this case, the repeater antennas may always operate as being connected to the amplifier corresponding to the RX (UL) path.

The exemplary embodiments of the repeater described with reference to at least one of FIGS. 20A to 23 are merely examples for convenience of description, and the repeater may be expanded or modified in the communication system.

In an exemplary embodiment of the communication system, the second type repeater described with reference to FIGS. 20A and 20B may be classified into more specific sub-types. For example, a specific sub-type repeater may be limited to being able to receive only a PBCH (or MIB). A specific sub-type repeater may be limited to being able to receive at least some of a MIB and SIBs. A specific sub-type repeater may be limited to being able to receive at least some of RRC configurations (such as cell-specific RRC configurations).

In an exemplary embodiment of the communication system, the repeater is not limited to the configuration schemes according to the first to third exemplary embodiments of the wireless repeater configuration in the communication system described with reference to FIGS. 21 to 23, and may have more various types of configurations. For example, the repeater may be configured to include multiple amplifiers per one TX (DL) path and/or one RX (UL) path.

In an exemplary embodiment of the communication system, the NWC repeater may be configured identically or similarly to the first to third exemplary embodiments of the wireless repeater configuration in the communication system described with reference to FIGS. 21 to 23. The NWC repeater may need to transmit two different uplink signals. For example, the NWC repeater may need to transmit an uplink signal of the repeater-MT and a signal obtained by amplifying an uplink signal of a terminal received at the repeater antenna #2. In an exemplary embodiment of the communication system, a transmission power of each uplink signal may be determined identically or similarly to Equation 5.

$$P ( i , l ) = min \{ \begin{matrix}{P}_{CMAX} ( i ) \\ {P}_{0} ( i ) + 10 log ( {2}^{μ} \times {M}_{RB} ) + α ( i ) \times PL + Δ ( i ) + f ( i , l )\end{matrix} \qquad [ Equation 5 ]$$

In Equation 5, i may indicate a transmission occasion. 1 may indicate a closed loop power control adjustment state. P_{CMAX}(i) may refer to the maximum transmission power of the terminal (here, repeater). P₀(i) may refer to a nominal transmission power of the terminal (here, repeater). 21 may indicate a subcarrier spacing. M_{RB} may mean the number of RBs allocated to uplink transmission. α(i) may mean a fractional power control coefficient. PL may mean a measured pathloss. Δ(i) may mean an offset according to an MCS. f(i, l) may mean a closed loop power control value.

Equation 5 is merely an example for convenience of description, and the uplink transmission power may be determined in various manners other than that shown in Equation 5. For example, the types and definitions of terms in Equation 5 may change depending on the type of channel or signal (e.g., PUSCH, PUCCH, SRS, PRACH, etc.) transmitted at the transmission occasion i.

Referring to Equation 5, if a value of an instantaneous transmission power of the uplink signal of the repeater, which is determined at a certain transmission occasion, is greater than the value of the maximum transmission power (i.e., P_{CMAX}) determined according to implementation of the repeater or separate configuration of the base station, the transmission power at the corresponding transmission occasion may be determined as the maximum transmission power value (i.e., P_{CMAX}).

The repeater may need to transmit an uplink signal #1 and an uplink signal #2, which are different from each other. Here, the signal #1 may mean an uplink signal of the repeater-MT. The signal #1 may be transmitted on a control link. The signal #2 may refer to a signal obtained by amplifying the terminal's uplink signal received at the repeater antenna #2. The signal #2 may be transmitted on a backhaul link. A relationship between the repeater's multiplexing operation and the signals #1 and #2 may be classified as follows.

Time Division Multiplexing (TDM) mode: The signal #1 and the signal #2 are transmitted using different time resources.

Frequency Division Multiplexing (FDM) mode: The signal #1 and the signal #2 are transmitted using different frequency resources. For example, a time resource through which the signal #1 is transmitted and a time resource through which the signal #2 is transmitted may be the same or partially overlap with each other.

Spatial Division Multiplexing (SDM) mode: The signal #1 and the signal #2 are transmitted using different spatial resources (e.g., beam, antenna domain, etc.). For example, a time/frequency resource through which the signal #1 is transmitted and a time/frequency resource through which the signal #2 is transmitted may be the same or partially overlap with each other.

When the repeater operates in the TDM mode, a transmission power P_{control} of the signal #1 transmitted on the control link and a transmission power P_{Backhaul} of the signal #2 transmitted on the backhaul link may satisfy a relationship expressed in Equation 6, with respect to a transmission occasion i.

$${P}_{Backhaul} ( i ) = {P}_{Control} ( i ) \leq {P}_{CMAX} ( i ) \qquad [ Equation 6 ]$$

When the repeater operates in the TDM mode, transmission power control for the control link and transmission power control for the backhaul link may be performed independently.

When a single amplifier (or single amplifier group) is used for the RX (UL) path in the repeater and the repeater operates in the FDM mode or SDM mode, a transmission power P_{Control} of the signal #1 transmitted on the control link and a transmission power P_{Backhaul} of the signal #2 transmitted on the backhaul link may satisfy a relationship of Equation 7 with respect to the transmission occasion i.

$${P}_{Backhaul} ( i ) + {P}_{Control} ( i ) \leq {P}_{CMAX} ( i ) \qquad [ Equation 7 ]$$

Referring to Equation 7, it may be necessary to consider a sum of the transmission power for the control link and the transmission power for the backhaul link.

When an operation of the repeater (or repeater-MT) is not defined for a case in which Equation 7 is not satisfied (i.e., case that P_{Backhaul}(i)+P_{Control}(i)>P_{CMAX} (i)), the base station and the repeater may have different understandings for the transmission powers of the signal #1 and the signal #2.

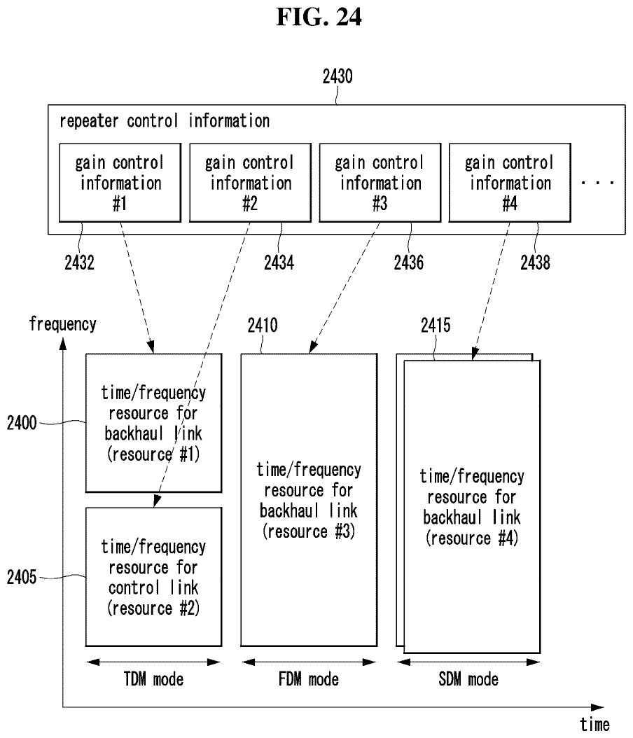

A technique may be required to prevent such the inconsistency or ambiguity from occurring and to efficiently control the transmission powers of the repeater's uplink signals. Hereinafter, with reference to FIGS. 24 to 27, exemplary embodiments of a wireless repeater transmission power control method will be described. Operations according to the exemplary embodiments of the wireless repeater transmission power control method described with reference to FIGS. 24 to 27 may be applied identically or similarly even when the transmission power of the repeater is controlled based on a criterion other than an absolute value of the transmission power. For example, the operations according to the exemplary embodiments of the wireless repeater transmission power control method may be similarly applied even when the transmission power of the repeater is controlled based on a relative value such as repeater gain control.

The problem of ambiguous repeater transmission power control (or allocation, distribution, etc.) depending on the multiplexing mode may also occur identically or similarly in other multiplexing operation modes other than the FDM and SDM. Here, other multiplexing operation modes may include a multiplexing operation mode according to a DL-UL direction (or DFU configuration/indication), a multiplexing operation mode according to a beam direction or antenna classification, and the like. The exemplary embodiments of the wireless repeater transmission power control method to be described with reference to FIGS. 24 to 27 may be applied identically or similarly to other multiplexing operation modes.

In FIGS. 24 to 27, the operations according to the exemplary embodiments of the wireless repeater transmission power control method will be described based on operations of the repeater-MT, but this is merely an example for convenience of description, and the exemplary embodiments of the wireless repeater transmission power control method are not limited thereto. For example, the operations according to the exemplary embodiments of the wireless repeater transmission power control method to be described with reference to FIGS. 24 to 27 may be understood or expanded as operations of a terminal (e.g., UE, UT, etc.) rather than the repeater-MT.

FIG. 24 is a conceptual diagram for describing a first exemplary embodiment of a wireless repeater transmission power control method.

Referring to FIG. 24, a repeater may transmit a plurality of types of uplink signals. For example, the repeater may need to transmit a signal #1 and a signal #2, which are different uplink signals. Here, the signal #1 may refer to an uplink signal of a repeater-MT, and may be transmitted on a control link. The signal #2 may refer to a signal obtained by amplifying an uplink signal of a terminal, which is received at a repeater antenna #2, and may be transmitted on a backhaul link. Hereinafter, in describing the first exemplary embodiment of the wireless repeater transmission power control method with reference to FIG. 24, description redundant with those described with reference to FIGS. 1 to 23 may be omitted.

In the first exemplary embodiment of the wireless repeater transmission power control method, the repeater (or repeater-MT) may determine a transmission power for each operation mode based on one or more power control indications or gain control indications received from a base station.

Specifically, the base station may transmit signaling including one or more repeater control information 2430 to the repeater. Here, the signaling may be L1 (PHY, DCI) signaling, L2 (MAC CE) signaling, L3 (RRC) signaling, and/or the like. The repeater control information 2430 may include a plurality of types of control information 2432, 2434, 2436, and 2438 for power control or gain control. Each of the plurality of types of control information 2432, 2434, 2436, and 2438 may be associated with or mapped to one or more time/frequency/space resources 2400, 2405, 2410, and 2415. Here, a ‘time/frequency/space resource’ may refer to one of a time resource, frequency resource, and space resource. Alternatively, a ‘time/frequency/space resources’ may refer to a resource constructed based on a combination of two or more elements among a time resource, frequency resource, and space resource. For example, a time/frequency/space resource may be a time-frequency resource.

In FIG. 24, control information #1 2432 may be associated with a resource #1 2400 for the backhaul link. Control information #2 2434 may be associated with a resource #2 2405 for the control link. Control information #3 2436 may be associated with a resource #3 2410 for the backhaul link. Control information #4 2438 may be associated with a resource #4 2415 for the backhaul link and control link.

At a specific transmission occasion corresponding to each of the one or more time/frequency/space resources 2400, 2405, 2410, and 2415, a specific multiplexing mode may be applied. In FIG. 24, the FDM mode may be applied to a time period to which the resource #1 2400 and the resource #2 2405 are mapped. The TDM mode may be applied to a time period to which the resource #3 2410 is mapped. The SDM mode may be applied to a time period to which the resource #4 2415 is mapped.

The base station may set a power value (or gain value) applied at a transmission occasion when the repeater operates in the FDM mode or SDM mode to be relatively smaller than a power value (or gain value) applied at a transmission occasion when the repeater operates in the TDM mode. This may be a configuration to satisfy Equation 7 in the FDM mode or SDM mode.

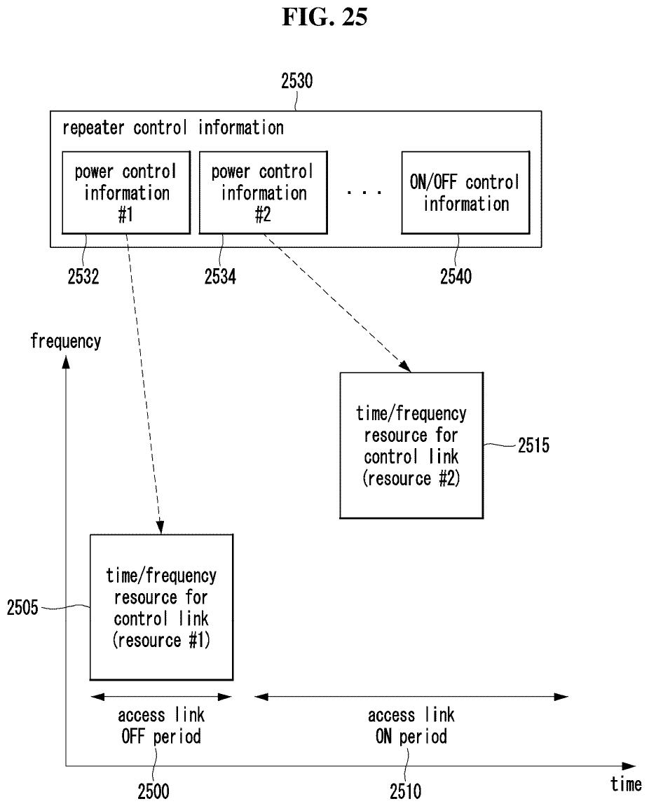

FIG. 25 is a conceptual diagram for describing a second exemplary embodiment of a wireless repeater transmission power control method.

Referring to FIG. 25, a repeater may transmit a plurality of types of uplink signals. For example, the repeater may need to transmit a signal #1 and a signal #2, which are different uplink signals. Here, the signal #1 may refer to an uplink signal of a repeater-MT, and may be transmitted on a control link. The signal #2 may refer to a signal obtained by amplifying an uplink signal of a terminal, which is received at a repeater antenna #2, and may be transmitted on a backhaul link. Hereinafter, in describing the second exemplary embodiment of the wireless repeater transmission power control method with reference to FIG. 25, description redundant with those described with reference to FIGS. 1 to 24 may be omitted.

In the second exemplary embodiment of the wireless repeater transmission power control method, the repeater (or repeater-MT) may determine a transmission power for each operation mode based on one or more power control indications (or gain control indications) and ON/OFF control indication received from the base station.

Specifically, the base station may transmit signaling including one or more repeater control information 2530 to the repeater. The repeater control information 2530 may include a plurality of types of control information 2532 and 2534 for power control or gain control. Each of the plurality of types of control information 2532 and 2534 may be associated with or mapped to one or more time/frequency/space resources 2505 and 2515.

The signaling transmitted from the base station to the repeater may further include repeater ON/OFF control information 2540. The repeater ON/OFF control information 2540 may be included in the repeater control information 2530, which includes the plurality of types of control information 2532 and 2534 for power control or gain control. Alternatively, the repeater ON/OFF control information 2540 may be included in control information that is different from the repeater control information 2530.

In the second exemplary embodiment of the wireless repeater transmission power control method, the repeater ON/OFF control information 2540 may include ON/OFF control information for some or all of the access link, backhaul link, and control link. When the repeater ON/OFF control information 2540 includes ON/OFF information for the access link (or backhaul link), an ON period or an OFF period of the access link (or backhaul link) may be determined depending on the ON/OFF information.

When an ON/OFF period of a specific link is configured, the repeater (or repeater-MT) may have different control link transmission power margins for an ON period and an OFF period. Taking this into account, the base station may configure or indicate so that the plurality of types of control information 2532 and 2534 for power control or gain control are associated with (or mapped to) different resources 2505 and 2515 included in different ON/OFF periods. In FIG. 25, the control information #1 2532 may be associated with the resource #1 2505 for the control link. Here, the resource #1 2505 may be located in an access link OFF period 2500. The control information #2 2534 may be associated with the resource #2 2515 for the control link. Here, the resource #2 2515 may be located in an access link ON period 2510.

In the second exemplary embodiment of the wireless repeater transmission power control method, the base station may indicate or configure a relatively small transmission power value (or gain value) at a transmission occasion of the repeater, which is included in the ON period of the access link (or backhaul link). On the other hand, the base station may indicate or configure a relatively large transmission power value (or gain value) at a transmission occasion of the repeater, which is included in the OFF period the access link (or backhaul link). This may be a configuration to satisfy Equation 7 in the FDM mode or SDM mode.

In the second exemplary embodiment of the wireless repeater transmission power control method, the base station may indicate or configure a relatively small transmission power value (or gain value) at a transmission occasion of the repeater, which is included in the ON period of the control link. On the other hand, the base station may indicate or configure a relatively large transmission power value (or gain value) at a transmission occasion of the repeater, which is included in the OFF period of the control link. This may be a configuration to satisfy Equation 7 in the FDM mode or SDM mode.

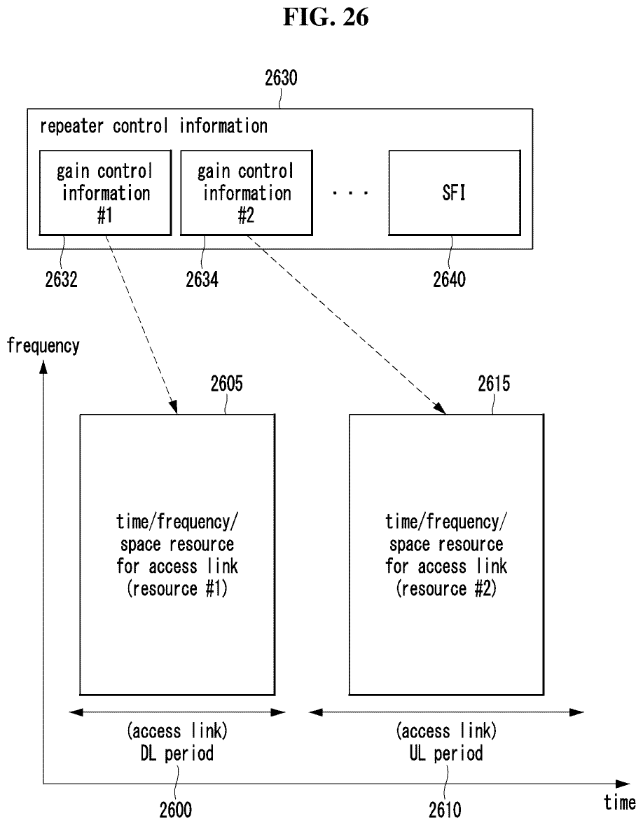

FIG. 26 is a conceptual diagram for describing a third exemplary embodiment of a wireless repeater transmission power control method.

Referring to FIG. 26, a repeater may transmit a plurality of types of uplink signals. For example, the repeater may need to transmit a signal #1 and a signal #2, which are different uplink signals. Here, the signal #1 may refer to an uplink signal of a repeater-MT, and may be transmitted on a control link. The signal #2 may refer to a signal obtained by amplifying an uplink signal of a terminal, which is received at a repeater antenna #2, and may be transmitted on a backhaul link. Hereinafter, in describing the third exemplary embodiment of the wireless repeater transmission power control method with reference to FIG. 26, description redundant with those described with reference to FIGS. 1 to 25 may be omitted.

In the third exemplary embodiment of the wireless repeater transmission power control method, the repeater may determine a transmission power for each operation mode based on one or more power control indications (or gain control indications) and a control indication for a communication direction (or slot format), which are received from a base station.

Specifically, the base station may transmit signaling including one or more repeater control information 2630 to the repeater. The repeater control information 2630 may include a plurality of types of control information 2632 and 2634 for power control or gain control. Each of the plurality of type of control information 2632 and 2634 may be associated with or mapped to one or more time/frequency/space resources 2605 and 2615.

The signaling transmitted from the base station to the repeater may further include communication direction control information 2640 (e.g., SFI) indicating a communication direction or a slot format. The communication direction control information 2640 may be included in the repeater control information 2630 including the plurality of types of control information 2632 and 2634 for power control or gain control. Alternatively, the communication direction control information 2640 may be included in control information that is different from the repeater control information 2630.

In the third exemplary embodiment of the wireless repeater transmission power control method, the communication direction control information 2640 may include control information of communication direction(s) or slot format(s) for some or all of the access link, backhaul link, and control link. For a specific type of repeater (e.g., full-duplex repeater), different slot formats may be allocated to the access link, backhaul link, and control link. For example, DL may be indicated for the access link or backhaul link, and UL may be indicated for the control link.

When a DL period and an UL period of a specific link are configured, the repeater (or repeater-MT) may have different control link transmission power margins for the DL period and the UL period. Taking this into account, the base station may configure or indicate so that the plurality of types of control information 2632 and 2634 for power control or gain control are associated with (or mapped to) different resources 2605 and 2615 included in different DL/UL periods. In FIG. 26, control information #1 2632 may be associated with a resource #1 2605 for the access link. Here, the resource #1 2605 may be located in an access link DL period 2600. Control information #2 2634 may be associated with a resource #2 2615 for the access link. Here, the resource #2 2615 may be located in an access link UL period 2610.

In the third exemplary embodiment of the wireless repeater transmission power control method, considering that the FDM mode or SDM mode operation is possible at a transmission time of the repeater, which is included in the UL period of the access link (or backhaul link), the base station may indicate (or configure a relatively small transmission power value (or gain value). On the other hand, the base station may indicate or configure a relatively large transmission power value (or gain value) at a transmission time of the repeater, which is included in the DL period of the access link (or backhaul link). This may be a configuration to satisfy Equation 7 in the FDM mode or SDM mode.

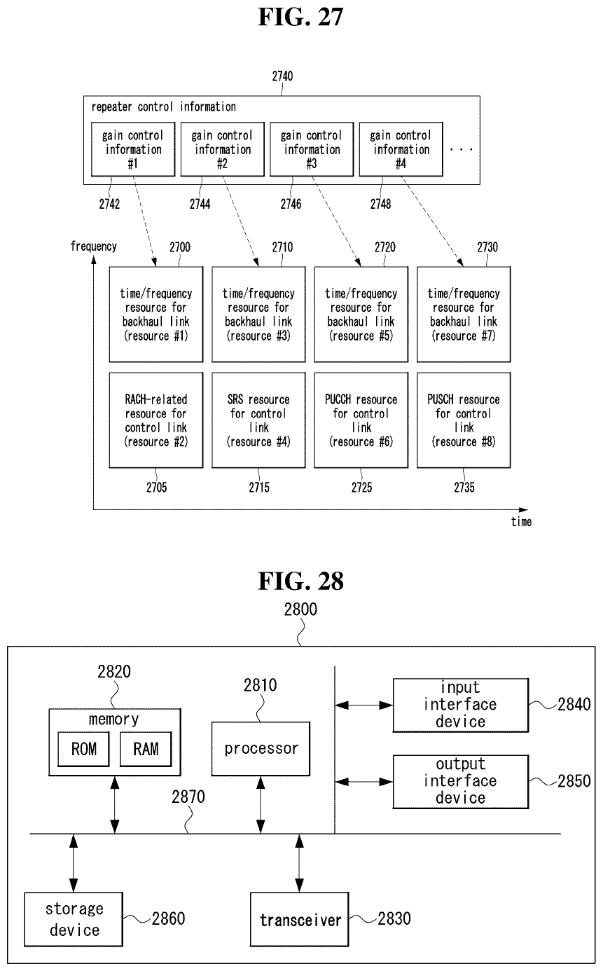

FIG. 27 is a conceptual diagram for describing a fourth exemplary embodiment of a wireless repeater transmission power control method.

Referring to FIG. 27, a repeater may transmit a plurality of types of uplink signals. For example, the repeater may need to transmit a signal #1 and a signal #2, which are different uplink signals. Here, the signal #1 may refer to an uplink signal of a repeater-MT, and may be transmitted on a control link. The signal #2 may refer to a signal obtained by amplifying an uplink signal of a terminal, which is received at a repeater antenna #2, and may be transmitted on a backhaul link. Hereinafter, in describing the fourth exemplary embodiment of the wireless repeater transmission power control method with reference to FIG. 27, description redundant with those described with reference to FIGS. 1 to 26 may be omitted.

In the fourth exemplary embodiment of the wireless repeater transmission power control method, the repeater may determine transmission power(s) according to time/frequency/space resource(s) allocated to the repeater (or repeater-MT) from a base station.

Specifically, the base station may transmit signaling including one or more repeater control information 2740 to the repeater. The repeater control information 2740 may include a plurality of types of control information 2742, 2744, 2746, and 2748 for power control or gain control. Each of the plurality of type of control information 2742, 2744, 2746, and 2748 may be associated with or mapped to one or more time/frequency/space resources 2700, 2710, 2720, and 2730 for the access link or backhaul link, or may be associated with or mapped to one or more time/frequency/space resources 2705, 2710, 2725, and 2735 for the control link.

Meanwhile, the base station may further transmit signaling to the repeater for allocation of uplink time/frequency/space resources for transmission of an uplink channel or signal. Here, the uplink channel or signal may mean, for example, PRACH, SRS, PT-RS, PUSCH, PUCCH, and/or the like. From the base station's perspective, uplink channels transmitted by the repeater may have different levels of importance.

For example, in FIG. 27, the repeater-MT may transmit a RACH-related resources 2705. The RACH-related resource 2705 may refer to a time/frequency/space resource for transmission of Msg1, Msg2, Msg3, Msg4, or HARQ for Msg4, as described with reference to FIG. 6. The RACH-related resources 2705 may affect the performance of the entire wireless links, including the control link as well as the backhaul link and the access link. Therefore, that is, the RACH-related resource 2705 may have higher importance than other repeater-MT uplink resources (e.g., 2700, 2710, 2715, 2720, 2725, 2730, 2735, and the like). In other words, for the RACH-related resource 2705, transmission power(s) or gain(s) greater than those of other repeater-MT uplink resources (e.g., 2700, 2710, 2715, 2720, 2725, 2730, 2735, and the like) may be configured.

As another example, in FIG. 27, the repeater-MT may transmit an SRS resource 2715. The RACH-related resources 2705 may be used to measure a channel condition across the wireless links, including the backhaul link and the access link as well as the control link. Therefore, the SRS resource 2715 may have higher importance than other repeater-MT uplink resources (e.g., 2700, 2705, 2710, 2720, 2725, 2730, 2735, and the like). In other words, for the SRS resource 2715, a transmission power or gain greater than transmission power(s) or gain(s) of other repeater-MT uplink resources (e.g., 2700, 2705, 2710, 2720, 2725, 2730, 2735, and the like) may be configured.

Meanwhile, in an exemplary embodiment of the communication system, the repeater may transmit a plurality of types of uplink signals. For example, the repeater may need to transmit a signal #1 and a signal #2, which are different uplink signals. Here, the signal #1 may refer to an uplink signal of a repeater-MT, and may be transmitted on a control link. The signal #2 may refer to a signal obtained by amplifying an uplink signal of a terminal, which is received at a repeater antenna #2, and may be transmitted on a backhaul link. Hereinafter, in describing the fifth exemplary embodiment of the wireless repeater transmission power control method, description redundant with those described with reference to FIGS. 1 to 27 may be omitted.

In the fifth exemplary embodiment of the wireless repeater transmission power control method, the repeater (or repeater-MT) may determine transmission power(s) based on a transmission power allocation priority for each channel/signal in a case (i.e., case that P_{Backhaul}(i)+P_{control}(i)>P_{CMAX}(i)) in which Equation 7 is not satisfied. The repeater may preferentially allocate a transmission power to a channel/signal with a high priority during uplink transmission. When an available transmission power is insufficient, the repeater may skip some or all of transmission powers of channels/signals with low priority.

When determining a priority of each channel/signal, the repeater may refer to at least one of the following schemes.
Scheme 5-1: A promise may be established so that the backhaul link (or signal/channel transmitted on the backhaul link) has a higher priority than the control link (or signal/channel transmitted on the control link). From the base station's perspective, this may be regarded as an attempt to ensure that an uplink quality of the terminal remains constant regardless of whether the control link of the repeater is used or not.
Scheme 5-2: A promise may be established so that the backhaul link (or signal/channel transmitted on the backhaul link) has a lower priority than the control link (or signal/channel transmitted on the control link). This may be regarded as an attempt to maintain the control quality of the repeater by allowing repeater control to determine the performance of the overall wireless link ‘base station-repeater-terminal’.
Scheme 5-3: A promise may be established so that cell-specific channels/signals/beams have a higher priority than other types of (e.g., terminal-specific) channels/signals/beams. This may be regarded as an attempt to maintain communication performance based on the cell-specific channel/signal/beam resources because the cell-specific channel/signal/beam resources can be shared between different terminals. The cell-specific channels/signals/beams may include at least one of a RACH-related resource and an SRS resource.
Scheme 5-4: The base station may configure or indicate a priority for each resource of each channel/signal/beam to the repeater. For example, the base station may configure priorities identical or similar to those in Table 16 by simultaneously considering maintaining of the signal quality of the control link and maximizing of the terminal performance.

TABLE 16

| Priority | Type |
|---|---|
| 1 | RACH-related resource on a control link |
| 2 | SRS resource on a control link |
| 3 | Resource on a backhaul link |
| 4 | PUCCH resource on a control link |
| 5 | PUSCH resource on a control link |

Scheme 5-5: For the purpose of maintaining a signal quality of the control ink, a specific resource among uplink time/frequency/space resources of the repeater-MT may be guaranteed to be transmitted based on a specific operation mode. For example, the base station and repeater may explicitly or implicitly establish a promise that the repeater transmits a RACH-related resource or SRS resource in the TDM mode. The repeater-MT may be allowed not to comply with (or, ignore) transmission power control or gain control for resources other than the specific resource when a specific operation mode for the specific resource is not guaranteed.

FIG. 28 is a block diagram illustrating an exemplary embodiment of a communication node constituting a communication system.

Referring to FIG. 28, a communication node 2800 may comprise at least one processor 2810, a memory 2820, and a transceiver 2830 connected to the network for performing communications. Also, the communication node 2800 may further comprise an input interface device 2840, an output interface device 2850, a storage device 2860, and the like. The respective components included in the communication node 2800 may communicate with each other as connected through a bus 2870.

However, each component included in the communication node 2800 may be connected to the processor 2810 via an individual interface or a separate bus, rather than the common bus 2870. For example, the processor 2810 may be connected to at least one of the memory 2820, the transceiver 2830, the input interface device 2840, the output interface device 2850, and the storage device 2860 via a dedicated interface.

The processor 2810 may execute a program stored in at least one of the memory 2820 and the storage device 2860. The processor 2810 may refer to a central processing unit (CPU), a graphics processing unit (GPU), or a dedicated processor on which methods in accordance with embodiments of the present disclosure are performed. Each of the memory 2820 and the storage device 2860 may be constituted by at least one of a volatile storage medium and a non-volatile storage medium. For example, the memory 2820 may comprise at least one of read-only memory (ROM) and random access memory (RAM).

The communication node 2800 may correspond to one of the communication nodes constituting the exemplary embodiments of the communication system described with reference to FIGS. 1 to 27. In an exemplary embodiment of the communication system, the communication node 2800 may correspond to a repeater. Alternatively, in an exemplary embodiment of the communication system, the communication node 2800 may correspond to a repeater-MT or repeater-DU constituting a repeater. The communication node 2800 may correspond to a terminal or a base station. In an exemplary embodiment of the communication system, the communication node 2800 may perform the same or similar operations as the operations of the repeater, repeater-MT, repeater-DU, terminal, base station, and/or the like described with reference to at least one of FIGS. 13 to 27.

The processor 2810 of the communication node 2800 may perform operations for communication with other communication nodes, such as upper node or lower node. The processor 2810 of the communication node 2800 may allow the communication node 2800 to perform communication based on the operations described with reference to at least one of the first to fifth exemplary embodiments of the power control method in the communication system.

When the communication node 2800 corresponds to a base station, the processor 2810 of the communication node 2800 may control the communication node 2800 to properly transmit wireless signals to the repeater and properly receive wireless signals from the repeater. The processor 2810 may indicate information on which operations to perform among the first to fifth exemplary embodiments of the power control method in the communication system.

When the communication node 2800 corresponds to a repeater, the processor 2810 of the communication node 2800 may control the communication node 2800 to properly transmit wireless signals to the repeater and to properly receive wireless signals from the repeater. The processor 2810 may indicate information on which operations to perform among the first to fifth exemplary embodiments of the power control method in the communication system.

The configurations described herein with reference to at least one of FIGS. 1 to 28 may be implemented by a certain device. For example, the communication node 2800 described with reference to FIG. 28 may be referred to as a device (e.g., first device, second device, etc.). The operations of communication nodes described with reference to FIGS. 13 to 28 may be performed by the first device, the second device, and/or the like. When the first device corresponds to a repeater, the first device may include a first transceiver. Here, the first transceiver may correspond to a repeater-MT. Alternatively, when the first device corresponds to a repeater, the first device may include a first transceiver and a second transceiver. Here, the first transceiver may correspond to a repeater-MT, and the second transceiver may correspond to a repeater-DU.

The first to fifth exemplary embodiments of the power control method in the communication system may not be considered mutually exclusive. The first to fifth exemplary embodiments of the power control method in the communication system may be combined with each other. For example, the repeater may determine a transmission power of the repeater based on the first exemplary embodiment of the power control method in the communication system, and at the same time, may additionally protect cell-specific channels/signals based on the fifth exemplary embodiment of the power control method in the communication system.

The repeater may report to the base station information on which of the configurations (or functions) according to the first to fifth exemplary embodiments of the power control method in the communication system are supported (or implemented). Such the reporting may be performed in the same or similar form as a UE capability report. Based on the report from the repeater, the base station may indicate what operation the repeater will perform through L1 signaling or higher layer signaling.

Hereinafter, a first exemplary embodiment of an operation method of a repeater in a communication system will be described. Among configurations according to the first exemplary embodiment of the operation method of the repeater, configurations for the repeater may be interpreted as configurations for a first device, configurations for a base station may be interpreted as configurations for a second device, and configurations for a terminal may be interpreted as configurations for a third device.

According to a first exemplary embodiment of an operation method of a repeater, the operation method of the repeater may comprise: receiving device control information for controlling the repeater from a second device; identifying one or more types of power control information related to uplink power control of the repeater, which are included in the device control information; identifying an association relationship between the one or more types of power control information and one or more resources for uplink transmission of the repeater; and determining one or more uplink transmission power values corresponding to the one or more resources, based on the one or more types of power control information associated with the one or more resources.

The operation method of the repeater may further comprise, before the determining of the one or more uplink transmission power values, identifying information on a multiplexing mode applied to each of the one or more resources, wherein the one or more types of power control information indicate one or more power reference values used to determine the one or more uplink transmission power values, and size(s) of the one or more power reference values indicated by the one or more types of power control information are determined differently depending on the multiplexing mode applied to each of the one or more resources associated with the one or more types of power control information.

The one or more types of power control information may include control information #1 and control information #2, the one or more resources may include a resource #1 and a resource #2, the control information #1 associated with the resource #1 may indicate a power reference value #1 used to determine an uplink transmission power value corresponding to the resource #1, the control information #2 associated with the resource #2 may indicate a power reference value #2 used to determine an uplink transmission power value corresponding to the resource #2, a multiplexing based on a time division scheme may be applied to the resource #1, a multiplexing based on at least one a frequency division scheme or a space division scheme may be applied to the resource #2, and the power reference value #1 may be greater than the power reference value #2.

The repeater may relay communication between a terminal and the base station, one or more links may be formed at least one of between the repeater and the base station and between the repeater and the terminal, and the operation method of the repeater may further comprise: identifying link ON/OFF control information that is received from the base station and indicates a period in which each of the one or more links is turned on/off, before determining the one or more uplink transmission power values, wherein the one or more types of power control information indicate one or more power reference values used to determine the one or more uplink transmission power values, and size(s) of the one or more power reference values indicated by the one or more types of power control information are determined differently depending on whether a link is turned on/off in the one or more resources associated with the one or more types of power control information.

The one or more types of power control information may include control information #3 and control information #4, the one or more resources may include a resource #3 and a resource #4, the control information #3 associated with the resource #3 may indicate a power reference value #3 used to determine an uplink transmission power value corresponding to the resource #3, the control information #4 associated with the resource #4 may indicate a power reference value #4 used to determine an uplink transmission power value corresponding to the resource #4, a first link among the one or more links may be turned off in a time period where the resource #3 is located and turned on in a time period where the resource #4 is located, based on the link ON/OFF control information, and the power reference value #3 may be greater than the power reference value #4.

The repeater may relay communication between a terminal and the base station, one or more links are formed at least one of between the repeater and the base station and between the repeater and the terminal, and the operation method of the repeater may further comprise: identifying communication direction control information that is received from the base station and indicates a communication direction of each of the one or more links, before determining the one or more uplink transmission power values, wherein the one or more types of power control information indicate one or more power reference values used to determine the one or more uplink transmission power values, and size(s) of the one or more power reference values indicated by the one or more types of power control information are determined differently depending on communication direction(s) in the one or more resources associated with the one or more types of power control information.

The one or more types of power control information may include control information #5 and control information #6, the one or more resources may include a resource #5 and a resource #6, the control information #5 associated with the resource #5 may indicate a power reference value #5 used to determine an uplink transmission power value corresponding to the resource #5, the control information #6 associated with the resource #6 may indicate a power reference value #6 used to determine an uplink transmission power value corresponding to the resource #6, a second link among the one or more links may be configured as a downlink in a time period where the resource #5 is located, and may be configured as an uplink in a time period where the resource #6 is located, based on the communication direction control information, and the power reference value #5 may be greater than the power reference value #6.

The one or more types of power control information may indicate one or more power reference values used to determine the one or more uplink transmission power values, and size(s) of the one or more power reference values indicated by the one or more types of power control information may be determined differently depending on types of signals transmitted and received through the one or more resources associated with the one or more types of power control information.

The determining of the one or more uplink transmission power values may comprise: determining one or more transmission power candidate values respectively corresponding to the one or more resources; in response to that a sum of the one or more transmission power candidate values exceeds a preset available transmission power value, comparing respective priorities of the one or more resources; and readjusting at least some of the one or more transmission power candidate values, based on the respective priorities of the one or more resources and the available transmission power value.

The comparing of the respective priorities of the one or more resources may comprise: determining that a priority of a resource for a backhaul link among the one or more resources is higher than a priority of a resource for a control link.

The comparing of the respective priorities of the one or more resources may comprise: determining that a priority of a resource for a control link among the one or more resources is higher than a priority of a resource for a backhaul link.

The comparing of the respective priorities of the one or more resources may comprise: determining that a priority of a resource for a cell-specific signal among the one or more resources is higher than a priority of a resource for a terminal-specific signal.

The operation method of the repeater may further comprise, before determining the one or more uplink transmission power values, identifying a first signaling received from the base station, wherein the first signaling indicates the repeater to apply a multiplexing based on a time division scheme to a resource for a cell-specific signal.

A control link for controlling the repeater and a backhaul link for communication between the base station and the terminal may be formed between the repeater and the base station, and each of the one or more resources may correspond to at least one of the backhaul link or the control link.

The repeater may relay communication between a terminal and the base station, a control link for controlling the repeater and a backhaul link for communication between the terminal and the base station may be formed between the repeater and the base station, and an access link for communication between the base station and the terminal may be formed between the repeater and the terminal.

According to exemplary embodiments of a power control method and apparatus in a communication system, a repeater and a base station can communicate with each other through a control link used for controlling the repeater itself and a backhaul link used for relaying communication between a terminal and the base station. In order to efficiently determine uplink transmission powers of the repeater for the control link and backhaul link, a power control scheme and a power determination scheme can be used based on multiplexing mode information, link ON/OFF period information, uplink/downlink period information, and/or predetermined priority criteria. Accordingly, the repeater can efficiently transmit its own uplink signals and amplify and retransmit signals received from the terminal.

However, the effects that can be achieved by the power control method and apparatus according to the exemplary embodiments of the present disclosure in the communication system are not limited to those mentioned above, and other effects not mentioned may be clearly understood by those of ordinary skill in the art to which the present disclosure belongs from the configurations described in the present disclosure.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. An operation method of a first device, comprising:
receiving device control information for controlling the first device from a second device;
identifying one or more types of power control information related to uplink power control of the first device, which are included in the device control information;
identifying an association relationship between the one or more types of power control information and one or more resources for uplink transmission of the first device; and
determining one or more uplink transmission power values corresponding to the one or more resources, based on the one or more types of power control information associated with the one or more resources.

2. The operation method according to claim 1, further comprising, before the determining of the one or more uplink transmission power values, identifying information on a multiplexing mode applied to each of the one or more resources,
wherein the one or more types of power control information indicate one or more power reference values used to determine the one or more uplink transmission power values, and size(s) of the one or more power reference values indicated by the one or more types of power control information are determined differently depending on the multiplexing mode applied to each of the one or more resources associated with the one or more types of power control information.

3. The operation method according to claim 2, wherein the one or more types of power control information include control information #1 and control information #2, the one or more resources include a resource #1 and a resource #2, the control information #1 associated with the resource #1 indicates a power reference value #1 used to determine an uplink transmission power value corresponding to the resource #1, the control information #2 associated with the resource #2 indicates a power reference value #2 used to determine an uplink transmission power value corresponding to the resource #2, a multiplexing based on a time division scheme is applied to the resource #1, a multiplexing based on at least one a frequency division scheme or a space division scheme is applied to the resource #2, and the power reference value #1 is greater than the power reference value #2.

4. The operation method according to claim 1, further comprising: when the first device relays communication between a third device and the second device, and one or more links are formed at least one of between the first and second devices and between the first and third devices, identifying link ON/OFF control information that is received from the second device and indicates a period in which each of the one or more links is turned on/off, before determining the one or more uplink transmission power values,
wherein the one or more types of power control information indicate one or more power reference values used to determine the one or more uplink transmission power values, and size(s) of the one or more power reference values indicated by the one or more types of power control information are determined differently depending on whether a link is turned on/off in the one or more resources associated with the one or more types of power control information.

5. The operation method according to claim 4, wherein the one or more types of power control information include control information #3 and control information #4, the one or more resources include a resource #3 and a resource #4, the control information #3 associated with the resource #3 indicates a power reference value #3 used to determine an uplink transmission power value corresponding to the resource #3, the control information #4 associated with the resource #4 indicates a power reference value #4 used to determine an uplink transmission power value corresponding to the resource #4, a first link among the one or more links is turned off in a time period where the resource #3 is located and turned on in a time period where the resource #4 is located, based on the link ON/OFF control information, and the power reference value #3 is greater than the power reference value #4.

6. The operation method according to claim 1, further comprising: when the first device relays communication between a third device and the second device, and one or more links are formed at least one of between the first and second devices and between the first and third devices, identifying communication direction control information that is received from the second device and indicates a communication direction of each of the one or more links, before determining the one or more uplink transmission power values,
wherein the one or more types of power control information indicate one or more power reference values used to determine the one or more uplink transmission power values, and size(s) of the one or more power reference values indicated by the one or more types of power control information are determined differently depending on communication direction(s) in the one or more resources associated with the one or more types of power control information.

7. The operation method according to claim 5, wherein the one or more types of power control information include control information #5 and control information #6, the one or more resources include a resource #5 and a resource #6, the control information #5 associated with the resource #5 indicates a power reference value #5 used to determine an uplink transmission power value corresponding to the resource #5, the control information #6 associated with the resource #6 indicates a power reference value #6 used to determine an uplink transmission power value corresponding to the resource #6, a second link among the one or more links is configured as a downlink in a time period where the resource #5 is located, and is configured as an uplink in a time period where the resource #6 is located, based on the communication direction control information, and the power reference value #5 is greater than the power reference value #6.

8. The operation method according to claim 1, wherein the one or more types of power control information indicate one or more power reference values used to determine the one or more uplink transmission power values, and size(s) of the one or more power reference values indicated by the one or more types of power control information are determined differently depending on types of signals transmitted and received through the one or more resources associated with the one or more types of power control information.

9. The operation method according to claim 1, wherein the determining of the one or more uplink transmission power values comprises:
determining one or more transmission power candidate values respectively corresponding to the one or more resources;
in response to that a sum of the one or more transmission power candidate values exceeds a preset available transmission power value, comparing respective priorities of the one or more resources; and
readjusting at least some of the one or more transmission power candidate values, based on the respective priorities of the one or more resources and the available transmission power value.

10. The operation method according to claim 9, wherein the comparing of the respective priorities of the one or more resources comprises: determining that a priority of a resource for a backhaul link among the one or more resources is higher than a priority of a resource for a control link.

11. The operation method according to claim 9, wherein the comparing of the respective priorities of the one or more resources comprises: determining that a priority of a resource for a control link among the one or more resources is higher than a priority of a resource for a backhaul link.

12. The operation method according to claim 9, wherein the comparing of the respective priorities of the one or more resources comprises: determining that a priority of a resource for a cell-specific signal among the one or more resources is higher than a priority of a resource for a terminal-specific signal.

13. The operation method according to claim 1, further comprising, before determining the one or more uplink transmission power values, identifying a first signaling received from the second device, wherein the first signaling indicates the first device to apply a multiplexing based on a time division scheme to a resource for a cell-specific signal.

14. The operation method according to claim 1, wherein the first device is a repeater and the second device is a base station that communicates with a terminal through the repeater, a control link for controlling the first device and a backhaul link for communication between the second device and the terminal are formed between the first and second devices, and each of the one or more resources corresponds to at least one of the backhaul link or the control link.

15. The operation method according to claim 1, wherein the first device relays communication between a third device and the second device, a control link for controlling the first device and a backhaul link for communication between the second and third devices are formed between the first device and the second device, and an access link for communication between the second and third devices is formed between the first and third devices.

16. A first device comprising a processor,
wherein the processor causes the first device to perform:
receiving device control information for controlling the first device from a second device;
identifying one or more types of power control information related to uplink power control of the first device, which are included in the device control information;
identifying an association relationship between the one or more types of power control information and one or more resources for uplink transmission of the first device; and
determining one or more uplink transmission power values corresponding to the one or more resources, based on the one or more types of power control information associated with the one or more resources.

17. The first device according to claim 16, wherein the processor further causes the first device to perform: before the determining of the one or more uplink transmission power values, identifying information on a multiplexing mode applied to each of the one or more resources,
wherein the one or more types of power control information indicate one or more power reference values used to determine the one or more uplink transmission power values, and size(s) of the one or more power reference values indicated by the one or more types of power control information are determined differently depending on the multiplexing mode applied to each of the one or more resources associated with the one or more types of power control information.

18. The first device according to claim 16, wherein when the first device relays communication between a third device and the second device, and one or more links are formed at least one of between the first and second devices and between the first and third devices, the processor further causes the first device to perform: identifying link ON/OFF control information that is received from the second device and indicates a period in which each of the one or more links is turned on/off, before determining the one or more uplink transmission power values,
wherein the one or more types of power control information indicate one or more power reference values used to determine the one or more uplink transmission power values, and size(s) of the one or more power reference values indicated by the one or more types of power control information are determined differently depending on whether a link is turned on/off in the one or more resources associated with the one or more types of power control information.

19. The first device according to claim 16, wherein when the first device relays communication between a third device and the second device, and one or more links are formed at least one of between the first and second devices and between the first and third devices, the processor further causes the first device to perform: identifying communication direction control information that is received from the second device and indicates a communication direction of each of the one or more links, before determining the one or more uplink transmission power values,
wherein the one or more types of power control information indicate one or more power reference values used to determine the one or more uplink transmission power values, and size(s) of the one or more power reference values indicated by the one or more types of power control information are determined differently depending on communication direction(s) in the one or more resources associated with the one or more types of power control information.

20. The first device according to claim 16, wherein the one or more types of power control information indicate one or more power reference values used to determine the one or more uplink transmission power values, and size(s) of the one or more power reference values indicated by the one or more types of power control information are determined differently depending on types of signals transmitted and received in the one or more resources associated with the one or more types of power control information.
